(19) United States
(12) Patent Application Publication
(10) Pub. No.: US 2025/0337551 A1
(43) Pub. Date: Oct. 30, 2025

(54) METHOD AND DEVICE IN A NODE USED FOR WIRELESS COMMUNICATION

(71) Applicant: Lu WU, Shanghai (CN)

(72) Inventor: Lu WU, Shanghai (CN)

(73) Assignee: SHANGHAI TUILUO COMMUNICATION TECHNOLOGY PARTNERSHIP (LIMITED PARTNERSHIP), Shanghai (CN)

(21) Appl. No.: 19/188,024

(22) Filed: Apr. 24, 2025

(30) Foreign Application Priority Data
Apr. 30, 2024 (CN) 202410546158.2

(51) Int. Cl. H04L 5/00; H04L 41/16; H04W 24/10

(52) U.S. Cl. CPC H04L 5/0057; H04L 5/0091; H04L 41/16; H04W 24/10

(57) ABSTRACT

The present application discloses a method and device in a node used for wireless communications. Receive a first configuration information block; the first configuration information block indicates a first resource set; perform a first operation, an input of the first operation depends on a measurement based on the first resource set; transmit a first signal, the first signal carries a first information set, and the first information set depends on an output of the first operation. The first information set comprises N information blocks, the N information blocks respectively comprise channel information for N time units, N being a positive integer greater than 1; an ordering of the N information blocks in the first information set depends on an ordering of the N time units.

### CROSS REFERENCE TO RELATED APPLICATIONS

This application claims the priority benefit of Chinese Patent Application CN202410546158.2, filed on Apr. 30, 2024, the full disclosure of which is incorporated herein by reference.

### BACKGROUND

### Technical Field

The present application relates to transmission methods and devices in wireless communication systems, and in particular to a scheme and device for channel information reporting in a wireless communication system.

### Related Art

In traditional wireless communications, a UE (User Equipment) acquires channel information by measuring downlink reference signals. This channel information includes, but is not limited to, one or more of CRI (CSI-RS Resource Indicator), RI (Rank Indicator), PMI (Precoding Matrix Indicator), or CQI (Channel Quality Indicator).

With the adoption of new technologies, the increase in the number of antennas, the diversification of application scenarios, and the improvement of system performance requirements, traditional measurement and reporting methods will bring a lot of redundancy overhead. Therefore, in NR R (release) 18, research on AI (Artificial Intelligence)/ML (Machine Learning) technologies was initiated to explore their impact on system performance and design. Compared to traditional processing methods, AI/ML has features such as being based on training and requiring deployment.

### SUMMARY

Applicants have found through researches that when AI/ML functions are introduced, the existing measurement mechanisms, reporting mechanisms, and related configuration signalings may not be able to meet AI/ML-driven requirements. To address the above problem, the present application provides a solution. It should be noted that although numerous embodiments of the present application are focused on the AI/ML, the present application is also applicable to other schemes, such as traditional CSI reporting schemes. In addition, adopting a unified solution across diverse scenarios (including but not limited to AI/ML-based solutions and conventional CSI reporting solutions) demonstrates significant advantages in reducing hardware complexity and costs. If no conflict is incurred, embodiments in a first node in the present application and the characteristics of the embodiments are also applicable to a second node, and vice versa. And the embodiments in the present application and the characteristics in the embodiments can be arbitrarily combined if there is no conflict.

In one embodiment, interpretations of the terminology in the present application refer to definitions given in the 3GPP TS38 series.

In one embodiment, interpretations of the terminology in the present application refer to definitions given in the 3GPP TS28 series.

The present application provides a method in a first node for wireless communications, comprising:
receiving a first configuration information block; the first configuration information block indicating a first resource set;
performing a first operation, an input of the first operation depending on a measurement based on the first resource set; transmitting a first signal, the first signal carrying a first information set, the first information set depending on an output of the first operation;
herein, the first information set comprises N information blocks, the N information blocks respectively comprise channel information for N time units, N being a positive integer greater than 1; an ordering of the N information blocks in the first information set depends on an ordering of the N time units.

In one embodiment, a problem to be solved in the present application comprises: how to acquire channel information for multiple time units based on a measurement of a resource set, and how to report the channel information for the multiple time units.

In one embodiment, in the above method, an ordering of channel information for multiple time units depends on an ordering of their corresponding time units. Advantages of the above method include ensuring consistency in the understanding of the transmitted information between the transmitting and receiving ends.

In one embodiment, advantages of the above method include improving the accuracy and real-time performance of channel information reporting, as well as reducing the reporting overhead.

According to one aspect of the present application, it is characterized in that the first node is a UE.

According to one aspect of the present application, it is characterized in that the first node is a relay node.

According to one aspect of the present application, it is characterized in that the first operation is training-based or AI-based.

In one embodiment, the AI (Artificial Intelligence) comprises Machine Learning (ML).

In one embodiment, advantages of the above method include better adapting to various application scenarios and terminals, thereby improving the flexibility and adaptability.

In one embodiment, advantages of the above method include improving the accuracy and real-time performance of channel information reporting.

According to one aspect of the present application, it is characterized in that any one of the N information blocks indicates at least one resource in a second resource set, and the second resource set comprises resources not belonging to the first resource set.

In one embodiment, advantages of the above method comprise: reducing the overhead required to acquire channel information.

In one embodiment, advantages of the above method comprise: reducing measurement resources required to acquire channel information.

According to one aspect of the present application, it is characterized in that the first configuration information block indicates a first identifier, and the first operation is associated with the first identifier.

In one embodiment, advantages of the above methods include simplified design and good flexibility.

According to one aspect of the present application, it is characterized in that in the first information set, the N information blocks are arranged in ascending order of their corresponding time units.

In one embodiment, advantages of the above methods include simplifying the design and ensuring the consistency in the understanding of the transmitted information by transmitting and receiving ends.

According to one aspect of the present application, it is characterized in that a first time unit group comprises time unit(s) with position belongs to a first position group among the N time units, and a second time unit group comprises time unit(s) with position belongs to a second position group among the N time units, the second position group being different from the first position group; a first information group comprises information block(s) corresponding to time unit(s) in the first time unit group among the N information blocks; a second information group comprises information block(s) corresponding to time unit(s) in the second time unit group among the N information blocks; in the first information set, the first information group is prior to the second information group.

In one embodiment, advantages of the above method include prioritizing channel information of time units on a first position group, better adapting to various application scenarios, and having good flexibility.

According to one aspect of the present application, it is characterized in that when the first information group comprises multiple information blocks among the N information blocks, in the first information set, the multiple information blocks in the first information group are arranged according to their corresponding time units in an ascending chronological order; when the second information group comprises multiple information blocks among the N information blocks, in the first information set, the multiple information blocks in the second information group are arranged according to their corresponding time units in an ascending chronological order.

In one embodiment, advantages of the above method include simplifying the design.

According to one aspect of the present application, it is characterized in that the first information set also indicates at least one of N, the N time units, or an ordering of the N time units.

In one embodiment, advantages of the above method include that the first node determines and reports at least one of N, the N time units, or an ordering of the N time units, which better adapts to various application scenarios and terminals, thereby improving the flexibility and adaptability.

According to one aspect of the present application, comprising:
deploying the first operation.

In one embodiment, advantages of the above method include reserving sufficient freedom for the first node, adapting to various scenarios and terminals, and offering both adaptability and flexibility.

In one embodiment, advantages of the above method comprise: training for the first operation can be performed outside the first node, thereby reducing the processing capability requirements and power consumption of the first node.

According to one aspect of the present application, it is characterized in that an output of the first operation comprises a first CSI, the first information set carries the first CSI, the first CSI serves as an input of a second operation by a target receiver of the first information set to generate a second CSI.

The present application provides a method in a second node for wireless communications, comprising:
transmitting a first configuration information block, the first configuration information block indicating a first resource set;
receiving a first signal, the first signal carrying a first information set;
herein, a target receiver of the first configuration information block performs a first operation, and an input of the first operation depends on a measurement based on the first resource set, and the first information set depends on an output of the first operation; the first information set comprises N information blocks, the N information blocks respectively comprise channel information for N time units, N being a positive integer greater than 1; an ordering of the N information blocks in the first information set depends on an ordering of the N time units.

According to one aspect of the present application, it is characterized in that the second node is a base station.

According to one aspect of the present application, it is characterized in that the second node is a UE.

According to one aspect of the present application, it is characterized in that the second node is a relay node.

According to one aspect of the present application, it is characterized in that any one of the N information blocks indicates at least one resource in a second resource set, and the second resource set comprises resources not belonging to the first resource set.

According to one aspect of the present application, it is characterized in that the first configuration information block indicates a first identifier, and the first operation is associated with the first identifier.

According to one aspect of the present application, it is characterized in that in the first information set, the N information blocks are arranged in ascending order of their corresponding time units.

According to one aspect of the present application, it is characterized in that a first time unit group comprises time unit(s) with position belongs to a first position group among the N time units, and a second time unit group comprises time unit(s) with position belongs to a second position group among the N time units, the second position group being different from the first position group; a first information group comprises information block(s) corresponding to time unit(s) in the first time unit group among the N information blocks; a second information group comprises information block(s) corresponding to time unit(s) in the second time unit group among the N information blocks; in the first information set, the first information group is prior to the second information group.

According to one aspect of the present application, it is characterized in that when the first information group comprises multiple information blocks among the N information blocks, in the first information set, the multiple information blocks in the first information group are arranged according to their corresponding time units in an ascending chronological order; when the second information group comprises multiple information blocks among the N information blocks, in the first information set, the multiple information blocks in the second information group are arranged according to their corresponding time units in an ascending chronological order.

According to one aspect of the present application, it is characterized in that the first information set also indicates at least one of N, the N time units, or an ordering of the N time units.

According to one aspect of the present application, comprising:
performing a second operation;
herein, an output of the first operation comprises a first CSI, the first information set carries the first CSI, and the first CSI serves as an input for the second operation to generate a second CSI.

According to one aspect of the present application, comprising:
deploying the second operation.

In one embodiment, advantages of the above method include reserving sufficient freedom for the second node, adapting to various scenarios and terminals, and offering both adaptability and flexibility.

In one embodiment, advantages of the above method comprise: training for the second operation can be performed outside the second node, thereby reducing the processing capability requirements and power consumption of the second node.

In one embodiment, the second operation is training-based or AI-based.

In one embodiment, the second operation is acquired through loading.

The present application provides a first node for wireless communications, comprising:
a first receiver, receiving a first configuration information block; the first configuration information block indicating a first resource set;
a first processor, performing a first operation, an input of the first operation depending on a measurement based on the first resource set; transmitting a first signal, the first signal carrying a first information set, the first information set depending on an output of the first operation;
herein, the first information set comprises N information blocks, the N information blocks respectively comprise channel information for N time units, N being a positive integer greater than 1; an ordering of the N information blocks in the first information set depends on an ordering of the N time units.

The present application provides a second node for wireless communications, comprising:
a second processor, transmitting a first configuration information block, the first configuration information block indicating a first resource set; receiving a first signal, the first signal carrying a first information set;
herein, a target receiver of the first configuration information block performs a first operation, and an input of the first operation depends on a measurement based on the first resource set, and the first information set depends on an output of the first operation; the first information set comprises N information blocks, the N information blocks respectively comprise channel information for N time units, N being a positive integer greater than 1; an ordering of the N information blocks in the first information set depends on an ordering of the N time units.

In one embodiment, the present application demonstrates the following advantages over conventional schemes:
Higher accuracy and real-time performance of channel information;
Lower latency;
Reduced air interface overhead;
Enhanced overall system performance;
Superior flexibility and adaptability;
Improved reliability and robustness.

### BRIEF DESCRIPTION OF THE DRAWINGS

Other features, objects and advantages of the present application will become more apparent from the detailed description of non-restrictive embodiments taken in conjunction with the following drawings:

FIG. 1 illustrates a flowchart of a first configuration information block, a first operation, and a first signal according to one embodiment of the present application;

FIG. 2 illustrates a schematic diagram of a network architecture according to one embodiment of the present application;

FIG. 3 illustrates a schematic diagram of a radio protocol architecture of a user plane and a control plane according to one embodiment of the present application;

FIG. 4 illustrates a schematic diagram of a first communication device and a second communication device according to one embodiment of the present application;

FIG. 5 illustrates a transmission between a first node and a second node according to one embodiment of the present application;

FIG. 6 illustrates a schematic diagram of a first operation according to one embodiment of the present application;

FIG. 7 illustrates a schematic diagram of a second resource set according to one embodiment of the present application;

FIG. 8 illustrates a schematic diagram of a first operation according to another embodiment of the present application;

FIG. 9 illustrates a schematic diagram of a first node deploying a first operation according to one embodiment of the present application;

FIG. 10 illustrates a schematic diagram of a first identifier according to one embodiment of the present application;

FIG. 11 illustrates a schematic diagram of a first information set according to one embodiment of the present application;

FIG. 12 illustrates a schematic diagram of a first CSI and a second CSI according to one embodiment of the present application;

FIG. 13 illustrates a schematic diagram of an ordering of N information blocks in a first information set depending on an ordering of N time units according to one embodiment of the present application;

FIG. 14 illustrates a schematic diagram of an ordering of N information blocks in a first information set depending on an ordering of N time units according to another embodiment of the present application;

FIG. 15 illustrates a schematic diagram of an ordering of information blocks in a first information group and a second information group according to one embodiment of the present application;

FIG. 16 illustrates a schematic diagram of an AI/ML-based processor according to one embodiment of the present application;

FIG. 17 illustrates a schematic diagram of being based on AI/ML according to one embodiment of the present application;

FIG. 18 illustrates a structure block diagram of a processor in a first node according to one embodiment of the present application;

FIG. 19 illustrates a structure block diagram of a processor in a second node according to one embodiment of the present application;

FIG. 20 illustrates a schematic diagram of first information set according to one embodiment of the present application.

### DESCRIPTION OF THE EMBODIMENTS

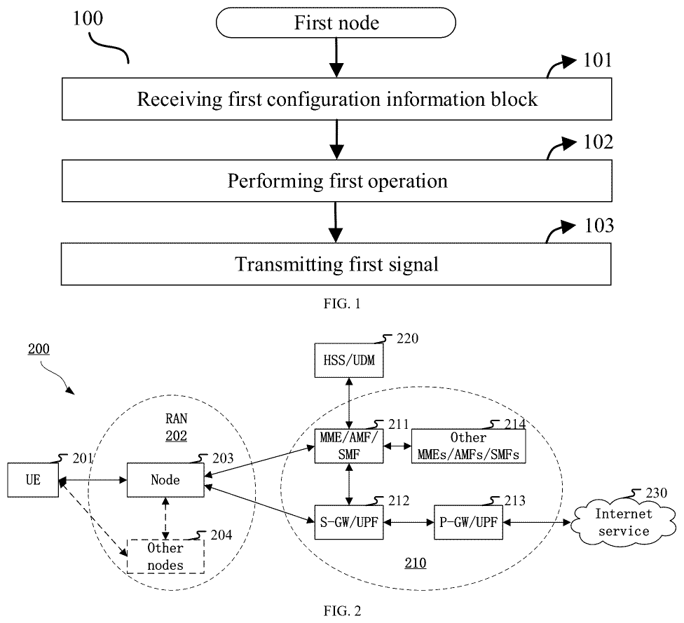

The technical scheme of the present application is described below in further details in conjunction with the drawings. It should be noted that the embodiments of the present application and the characteristics of the embodiments may be arbitrarily combined if no conflict is caused. Based on performance, flexibility, complexity, cost, and compatibility considerations, the skilled person in the art is motivated to flexibly combine embodiments in different drawings without conflict, such as but not limited to embodiments in FIG. 1 and FIGS. 5-20, embodiments in FIG. 5 and FIGS. 6-20, and so on.

### Embodiment 1

Embodiment 1 illustrates a flowchart of a first configuration information block, a first operation and a first signal according to one embodiment of the present application, as shown in FIG. 1. In 100 illustrated by FIG. 1, each block represents a step. And in particular, the order of steps in blocks does not represent a chronological order of characteristics between the steps.

In Embodiment 1, the first node receives a first configuration information block in step 101; performs a first operation in step 102; transmits a first signal in step 103; herein, the first configuration information block indicates a first resource set; an input of the first operation depends on a measurement based on the first resource set; the first signal carries a first information set, and the first information set depends on an output of the first operation; the first information set comprises N information blocks, the N information blocks respectively comprise channel information for N time units, N being a positive integer greater than 1; an ordering of the N information blocks in the first information set depends on an ordering of the N time units.

In one embodiment, the first configuration information block is carried by a higher-layer signaling.

In one embodiment, the first configuration information block is carried by a Radio Resource Control (RRC) signaling.

In one embodiment, the first configuration information block is carried by an RRC IE (Information Element).

In one embodiment, the first configuration information block is carried by at least one RRC IE.

In one embodiment, the first configuration information block comprises information in one or multiple fields in at least one RRC IE.

In one embodiment, the first configuration information block comprises information in one or multiple fields in each RRC IE in multiple RRC IEs.

In one embodiment, the first configuration information block is an RRC IE.

In one embodiment, the first configuration information block belongs to a CSI-ReportConfig IE.

In one embodiment, the first configuration information block belongs to ServingCellConfig IE.

In one embodiment, the first configuration information block belongs to a CSI-MeasConfig IE.

In one embodiment, the first configuration information block belongs to a ServingCellConfigCommon IE.

In one embodiment, the first configuration information block belongs to a ServingCellConfigCommonSIB IE.

In one embodiment, the first configuration information block comprises partial or all fields in a CSI-ReportConfig IE.

In one embodiment, the first configuration information block comprises partial or all fields in a ServingCellConfig IE.

In one embodiment, the first configuration information block comprises partial or all fields in a CSI-MeasConfig IE.

In one embodiment, the first configuration information block comprises partial or all fields in a ServingCellConfigCommon IE.

In one embodiment, the first configuration information block comprises partial or all fields in a ServingCellConfigCommonSIB IE.

In one embodiment, resources in the first resource set comprise at least one of antenna ports, TCI (Transmission Configuration Indication) status, QCL (Quasi Co-Location) information, time-frequency resources, time-frequency code resources, beams, RS resources, vectors, or matrices.

In one embodiment, the first resource set comprises one or more RS (Reference Signal) resource sets, where one RS resource set comprises one or multiple RS resources.

In one embodiment, the first resource set comprises at least one of at least one CSI-RS resource set, at least one CSI-SSB (Channel State Information-Synchronization Signal Block) resource set, or at least one CSI-IM (Channel State Information-Interference Measurement) resource set.

In one embodiment, the first resource set comprises at least one RS resource set used for channel measurement, and an RS resource set used for channel measurement comprises one or multiple RS resources.

In one embodiment, the first resource set comprises at least one RS resource set used for channel measurement, and least one RS resource set used for interference measurement; an RS resource set used for channel measurement comprises one or multiple RS resources, and an RS resource set used for interference measurement comprises one or multiple RS resources.

In one embodiment, the first resource set comprises at least one RS resource set used for interference measurement; an RS resource set used for interference measurement comprises one or multiple RS resources.

In one embodiment, an RS resource set used for channel measurement comprises one or multiple RS resources, where any RS resource in the RS resource set used for channel measurement is a CSI-RS resource or a synchronization signal resource.

In one embodiment, an RS resource set used for interference measurement comprises one or multiple RS resources.

In one embodiment, an RS resource set used for interference measurement comprises one or multiple RS resources, where any RS resource in the RS resource set used for interference measurement is a CSI-IM resource or an NZP (non-zero power) CSI-RS resource used for interference measurement.

In one embodiment, the first resource set comprises one or multiple RS resources.

In one embodiment, the first resource set comprises one or multiple downlink RS resources.

In one embodiment, the first resource set comprises one or multiple RS resources, and any RS resource in the first resource set is a CSI-RS (Channel State Information Reference Signal) resource or a synchronization signal resource.

In one embodiment, the synchronization signal resources comprise resources occupied by at least a synchronization signal.

In one embodiment, the synchronization signal resource is an SSB (Synchronization Signal Block).

In one embodiment, the synchronization signal resource is an SS/PBCH (synchronization signal/physical broadcast channel) block resource.

In one embodiment, the first configuration information block indicates at least one resource configuration, and the at least one resource configuration indicates the first resource set.

In one embodiment, the first configuration information block comprises at least one resource configuration, and the at least one resource configuration indicates the first resource set.

In one embodiment, a resource allocation is used to configure CSI resources.

In one embodiment, a resource configuration is an IE CSI-ResourceConfig.

In one embodiment, a resource configuration is carried by an RRC IE.

In one embodiment, a resource configuration is carried by a CSI-ResourceConfig IE.

In one embodiment, the first configuration information block indicates configuration information of the first resource set.

In one embodiment, the first configuration information block indicates an identifier of the first resource set.

In one embodiment, the first signal comprises a baseband signal.

In one embodiment, the first signal comprises a radio signal.

In one embodiment, the first signal comprises a radio-frequency signal.

In one embodiment, the first signal is transmitted on an uplink physical channel.

In one embodiment, the first signal is transmitted on a Physical Uplink Shared CHannel (PUSCH).

In one embodiment, the first signal is transmitted on a Physical Uplink Control Channel (PUCCH).

In one embodiment, the first information set only comprises N information blocks.

In one embodiment, the first information set comprises more than N information blocks, and the first information set comprises N information blocks and an information block other than the N information blocks.

In one embodiment, the first information set comprises multiple information blocks, and a number of information block(s) comprised in the first information set is not less than N.

In one embodiment, a number of information blocks comprised in the first information block set is equal to N.

In one embodiment, a number of information blocks comprised in the first information block set is greater than N.

In one embodiment, the first information set comprises multiple information blocks, and the multiple information blocks comprised in the first information set comprises the N information blocks.

In one embodiment, an information block in the first information set, after undergoing channel coding, is used to generate the first signal.

In one embodiment, an information block in the first information set, after undergoing channel coding and modulation, is used to generate the first signal.

In one embodiment, an information block in the first information set, after undergoing bit sequence generation and channel coding, is used to generate the first signal.

In one embodiment, an information block in the first information set, after undergoing bit sequence generation, channel coding and modulation, is used to generate the first signal.

In one embodiment, an information block in the first information set is multiplexed into the first signal after undergoing bit sequence generation, code block segmentation and CRC attachment, channel coding, rate matching, and code block concatenation.

In one embodiment, an information block in the first information set, after undergoing bit sequence generation, code block segmentation and CRC attachment, channel coding, rate matching, and code block concatenation, is multiplexed onto a physical channel where the first signal is located.

In one embodiment, an ordering of the N time units refers to an ascending order of the N time units.

In one embodiment, an ordering of the N time units is autonomously determined by the first node.

In one embodiment, the first signal also indicates at least one of N, the N time units, or an ordering of the N time units.

In one embodiment, the first signal also carries an information block outside the first information set for indicating at least one of N, the N time units, or an ordering of the N time units.

In one embodiment, the N time units are time units spaced by Q time units in a first time unit set, where the first time unit set comprises more than N time units, Q being a positive integer; the first signal also carries Q.

In one embodiment, the N time units are time units spaced by Q time units in a first time unit set, where the first time unit set comprises more than N time units, Q being a positive integer; a value of Q is autonomously determined by the first node.

In one embodiment, the N time units are time units spaced by Q time units in a first time unit set, where the first time unit set comprises more than N time units, Q being a positive integer; Q is reported by the first node to a transmitter of the first configuration information.

In one embodiment, if and only if the first operation is training-based or AI-based, an ordering of the N information blocks in the first information set depends on an ordering of the N time units.

### Embodiment 2

Embodiment 2 illustrates a schematic diagram of a network architecture according to one embodiment of the present application, as shown in FIG. 2.

FIG. 2 illustrates the network architecture 200. The network architecture 200 is a 5G NR (New Radio)/LTE (Long-Term Evolution)/LTE-A (Long-Term Evolution Advanced) system, or, the network architecture 200 is the network architecture of 5G+, or the network architecture 200 is the network architecture of 6G, or the network architecture 200 is the network architecture adopted in the future evolution of 3GPP; the network architecture 200 May be called 5GS (5G System)/Evolved Packet System (EPS), or the network architecture 200 may be called 6GS (6G System); The Network architecture 200 comprises at least one of UE (User Equipment) 201, RAN (Radio Access Network) 202, core network 210, HSS (Home Subscriber Server)/the Unified Data Management (UDM) 220 and Internet Service 230. The network architecture 200 may be interconnected with other access networks. For simple description, the entities/interfaces are not shown. As shown in FIG. 2, the network architecture 200 provides packet switching services. Those skilled in the art will readily understand that various concepts presented throughout the present application can be extended to networks providing circuit switching services. The RAN includes the node 203. RAN can also include other nodes 204. The node 203 provides UE 201-oriented user plane and control plane protocol terminations. The node 203 may be connected to other nodes 204 via an Xn interface (e. g., backhaul)/X2 interface. The node 203 may be called a base station, a base transceiver station, a radio base station, a radio transceiver, a transceiver function, a Base Service Set (BSS), an Extended Service Set (ESS), a Transmitter Receiver Point (TRP) or some other applicable terms. the core network 210 is 5GC (5G Core Network)/EPC (Evolved Packet Core), or, the core network 210 is 6GC. The node 203 provides UE 201 with an access point to the core network 210. Examples of the UE 201 include cellular phones, smart phones, Session Initiation Protocol (SIP) phones, laptop computers, Personal Digital Assistant (PDA), satellite Radios, non-terrestrial base station communications, Satellite Mobile Communications, Global Positioning Systems (GPSs), multimedia devices, video devices, digital audio players (for example, MP3 players), cameras, game consoles, unmanned aerial vehicles (UAV), aircrafts, narrow-band Internet of Things (IoT) devices, machine-type communication devices, land vehicles, automobiles, wearable devices, or any other similar functional devices. Those skilled in the art also can call the UE 201 a mobile station, a subscriber station, a mobile unit, a subscriber unit, a wireless unit, a remote unit, a mobile device, a wireless device, a radio communication device, a remote device, a mobile subscriber station, an access terminal, a mobile terminal, a wireless terminal, a remote terminal, a handset, a user proxy, a mobile client, a client or some other appropriate terms. The node 203 is connected to the core network 210 through S1/NG interface. The core network 210 comprises a Mobility Management Entity (MME)/Authentication Management Field (AMF)/Session Management Function (SMF) 211, other MMEs/AMFs/SMFs 214, a Service Gateway (S-GW)/User Plane Function (UPF) 212 and a Packet Date Network Gateway (P-GW)/UPF 213. The MME/AMF/SMF 211 is a control node for processing a signaling between the UE 201 and the core network 210. Generally, the MME/AMF/SMF 211 provides bearer and connection management. All user Internet Protocol (IP) packets are transmitted through the S-GW/UPF 212, the S-GW/UPF 212 is connected to the P-GW/UPF 213. The P-GW provides UE IP address allocation and other functions. The P-GW/UPF 213 is connected to the Internet Service 230. Internet Services 230 includes operator-corresponding Internet Protocol services, which may specifically include Internet, Intranet, IMS (IP Multimedia Subsystem) and packet switching services.

In one embodiment, the first node comprises the UE 201.

In one embodiment, the second node comprises the node 203.

In one embodiment, a radio link between the UE 201 and the node 203 comprises a cellular network link.

In one embodiment, a transmitter of the first configuration information block comprises the node 203.

In one embodiment, a receiver of the first configuration information block comprises the UE 201.

In one embodiment, a transmitter of the first resource set comprises the node 203.

In one embodiment, a receiver of the first resource set comprises the UE 201.

In one embodiment, a transmitter of the first signal comprises the UE 201.

In one embodiment, a receiver of the first signal comprises the node 203.

### Embodiment 3

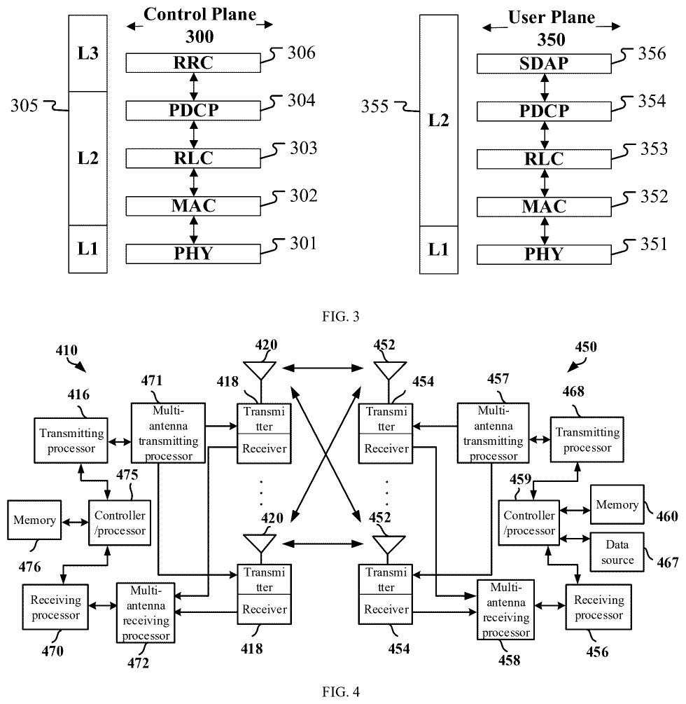

Embodiment 3 illustrates a schematic diagram of a radio protocol architecture of a user plane and a control plane according to one embodiment of the present application, as shown in FIG. 3.

Embodiment 3 illustrates a schematic diagram of an example of a radio protocol architecture of a user plane and a control plane according to one embodiment of the present application, as shown in FIG. 3. FIG. 3 is a schematic diagram illustrating an embodiment of a radio protocol architecture of a user plane 350 and a control plane 300. In FIG. 3, the radio protocol architecture for a first communication node (UE, gNB or an RSU in V2X) and a second communication node (gNB, UE or an RSU in V2X), or between two UEs is represented by three layers, which are a layer 1, a layer 2 and a layer 3, respectively. The layer 1 (L1) is the lowest layer and performs signal processing functions of various PHY layers. The L1 is called PHY 301 in the present application. The layer 2 (L2) 305 is above the PHY 301, and is in charge of a link between a first communication node and a second communication node, or between two UEs. L2 layer 305 includes MAC (Medium Access Control) sublayer 302, RLC (Radio Link Control) sublayer 303, and PDCP (Packet Data Convergence Protocol) sublayer 304, which terminate at the second communication node. The PDCP sublayer 304 provides multiplexing among variable radio bearers and logical channels. The PDCP sublayer 304 provides security by encrypting a packet and provides support for a first communication node handover between second communication nodes. The RLC sublayer 303 provides segmentation and reassembling of a higher-layer packet, retransmission of a lost packet, and reordering of a data packet so as to compensate the disordered receiving caused by HARQ. The MAC sublayer 302 provides multiplexing between a logical channel and a transport channel. The MAC sublayer 302 is also responsible for allocating between first communication nodes various radio resources (i.e., resource block) in a cell. The MAC sublayer 302 is also in charge of HARQ operation. The Radio Resource Control (RRC) sublayer 306 in layer 3 (L3) of the control plane 300 is responsible for acquiring radio resources (i.e., radio bearer) and configuring the lower layer with an RRC signaling between a second communication node and a first communication node device. The radio protocol architecture of the user plane 350 comprises layer 1 (L1) and layer 2 (L2). In the user plane 350, the radio protocol architecture for the first communication node and the second communication node is almost the same as the corresponding layer and sublayer in the control plane 300 for physical layer 351, PDCP sublayer 354, RLC sublayer 353 and MAC sublayer 352 in L2 layer 355, but the PDCP sublayer 354 also provides a header compression for a higher-layer packet so as to reduce a radio transmission overhead. The L2 layer 355 in the user plane 350 also includes Service Data Adaptation Protocol (SDAP) sublayer 356, which is responsible for the mapping between QoS flow and Data Radio Bearer (DRB) to support the diversity of traffic. Although not described in FIG. 3, the first communication node may comprise several higher layers above the L2 layer 355, such as a network layer (e.g., IP layer) terminated at a P-GW of the network side and an application layer terminated at the other side of the connection (e.g., a peer UE, a server, etc.).

In one embodiment, the radio protocol architecture in FIG. 3 is applicable to the first node.

In one embodiment, the radio protocol architecture in FIG. 3 is applicable to the second node.

In one embodiment, the higher layer in the present application refers to a layer above the physical layer.

In one embodiment, the first configuration information block is generated at the RRC sublayer 306.

In one embodiment, the first signal is generated at the PHY301 or the PHY351.

In one embodiment, the first signal is generated at the MAC sublayer 302 or the MAC sublayer 352.

### Embodiment 4

Embodiment 4 illustrates a schematic diagram of a first communication device and a second communication device according to one embodiment of the present application, as shown in FIG. 4. FIG. 4 is a block diagram of a first communication device 410 in communication with a second communication device 450 in an access network.

The first communication device 410 comprises a controller/processor 475, a memory 476, a receiving processor 470, a transmitting processor 416, a multi-antenna receiving processor 472, a multi-antenna transmitting processor 471, a transmitter/receiver 418 and an antenna 420.

The second communication device 450 comprises a controller/processor 459, a memory 460, a data source 467, a transmitting processor 468, a receiving processor 456, a multi-antenna transmitting processor 457, a multi-antenna receiving processor 458, a transmitter/receiver 454 and an antenna 452.

In a transmission from the first communication device 410 to the second communication device 450, at the first communication device 410, a higher layer packet from the core network is provided to a controller/processor 475. The controller/processor 475 provides a function of the L2 layer. In DL transmission, the controller/processor 475 provides header compression, encryption, packet segmentation and reordering, and multiplexing between a logical channel and a transport channel, and radio resource allocation for the second communication device 450 based on various priorities. The controller/processor 475 is also in charge of HARQ operation, retransmission of a lost packet, and a signaling to the second communication node 450. The transmitting processor 416 and the multi-antenna transmitting processor 471 perform various signal processing functions used for the L1 layer (that is, PHY). The transmitting processor 416 performs coding and interleaving so as to ensure an FEC (Forward Error Correction) at the second communication device 410 side, and the constellation mapping based on various modulation schemes (i.e., BPSK, QPSK, M-PSK, M-QAM, etc.). The multi-antenna transmitting processor 471 performs digital spatial precoding, including codebook-based precoding and non-codebook-based precoding, and beamforming on encoded and modulated symbols to generate one or more parallel streams. The transmitting processor 416 then maps each parallel stream into a subcarrier. The mapped symbols are multiplexed with a reference signal (i.e., pilot frequency) in time domain and/or frequency domain, and then they are assembled through Inverse Fast Fourier Transform (IFFT) to generate a physical channel carrying time-domain multicarrier symbol streams. After that the multi-antenna transmitting processor 471 performs transmission analog precoding/beamforming on the time-domain multicarrier symbol streams. Each transmitter 418 converts a baseband multicarrier symbol stream provided by the multi-antenna transmitting processor 471 into a radio frequency (RF) stream. Each radio frequency stream is later provided to different antennas 420.

In a transmission from the first communication device 410 to the second communication device 450, at the second communication device 450, each receiver 454 receives a signal via a corresponding antenna 452. Each receiver 454 recovers information modulated to the RF carrier, converts the radio frequency stream into a baseband multicarrier symbol stream to be provided to the receiving processor 456. The receiving processor 456 and the multi-antenna receiving processor 458 perform signal processing functions of the L1 layer. The multi-antenna receiving processor 458 performs receiving analog precoding/beamforming on a baseband multicarrier symbol stream from the receiver 454. The receiving processor 456 converts the baseband multicarrier symbol stream after receiving the analog precoding/beamforming from time domain into frequency domain using FFT. In frequency domain, a physical layer data signal and a reference signal are de-multiplexed by the receiving processor 456, wherein the reference signal is used for channel evaluation, while the data signal is subjected to multi-antenna detection in the multi-antenna receiving processor 458 to recover any second communication device 450-targeted parallel stream. Symbols on each parallel stream are demodulated and recovered in the receiving processor 456 to generate a soft decision. Then the receiving processor 456 decodes and de-interleaves the soft decision to recover the higher-layer data and control signal transmitted on the physical channel by the first communication node 410. Next, the higher-layer data and control signal are provided to the controller/processor 459. The controller/processor 459 performs functions of the L2 layer. The controller/processor 459 can be connected to a memory 460 that stores program code and data. The memory 460 can be called a computer readable medium. In downlink (DL) transmission, the controller/processor 459 provides demultiplexing between a transport channel and a logical channel, packet reassembling, decryption, header decompression and control signal processing so as to recover a higher-layer packet from the core network. The higher-layer packet is later provided to all protocol layers above the L2 layer, or various control signals can be provided to the L3 layer for processing. The controller/processor 459 also performs error detection using ACK and/or NACK protocols as a way to support HARQ operation.

In a transmission from the second communication device 450 to the first communication device 410, at the second communication device 450, the data source 467 is configured to provide a higher-layer packet to the controller/processor 459. The data source 467 represents all protocol layers above the L2 layer. Similar to a transmitting function of the first communication device 410 described in DL transmission, the controller/processor 459 performs header compression, encryption, packet segmentation and reordering, and multiplexing between a logical channel and a transport channel based on radio resource allocation of the first communication device 410 so as to provide the L2 layer functions used for the user plane and the control plane. The controller/processor 459 is also responsible for HARQ operation, retransmission of a lost packet, and a signaling to the first communication device 410. The transmitting processor 468 performs modulation mapping and channel coding. The multi-antenna transmitting processor 457 implements digital multi-antenna spatial precoding, including codebook-based precoding and non-codebook-based precoding, as well as beamforming. Following that, the generated parallel streams are modulated into multicarrier/single-carrier symbol streams by the transmitting processor 468, and then modulated symbol streams are subjected to analog precoding/beamforming in the multi-antenna transmitting processor 457 and provided from the transmitters 454 to each antenna 452. Each transmitter 454 first converts a baseband symbol stream provided by the multi-antenna transmitting processor 457 into a radio frequency symbol stream, and then provides the radio frequency symbol stream to the antenna 452.

In the transmission from the second communication device 450 to the first communication device 410, the function of the first communication device 410 is similar to the receiving function of the second communication device 450 described in the transmission from the first communication device 410 to the second communication device 450. Each receiver 418 receives a radio frequency signal via a corresponding antenna 420, converts the received radio frequency signal into a baseband signal, and provides the baseband signal to the multi-antenna receiving processor 472 and the receiving processor 470. The receiving processor 470 and multi-antenna receiving processor 472 collectively provide functions of the L1 layer. The controller/processor 475 provides functions of the L2 layer. The controller/processor 475 can be connected with the memory 476 that stores program code and data. The memory 476 can be called a computer readable medium. the controller/processor 475 provides de-multiplexing between a transport channel and a logical channel, packet reassembling, decryption, header decompression, control signal processing so as to recover a higher-layer packet from the second communication device 450. The higher-layer packet coming from the controller/processor 475 may be provided to the core network. The controller/processor 475 can also perform error detection using ACK and/or NACK protocols to support HARQ operation.

In one embodiment, the second communication device 450 comprises at least one processor and at least one memory. The at least one memory comprises computer program codes; the at least one memory and the computer program codes are configured to be used in collaboration with the at least one processor. The second communication device 450 at least: receives a first configuration information block; the first configuration information block indicates a first resource set; performs a first operation, an input of the first operation depends on a measurement based on the first resource set; transmits a first signal, the first signal carries a first information set, and the first information set depends on an output of the first operation; herein, the first information set comprises N information blocks, the N information blocks respectively comprise channel information for N time units, N being a positive integer greater than 1; an ordering of the N information blocks in the first information set depends on an ordering of the N time units.

In one embodiment, the second communication device 450 comprises a memory that stores a computer readable instruction program. The computer readable instruction program generates an action when executed by at least one processor. The action includes: receiving a first configuration information block; the first configuration information block indicating a first resource set; performing a first operation, an input of the first operation depending on a measurement based on the first resource set; transmitting a first signal, the first signal carrying a first information set, and the first information set depending on an output of the first operation; herein, the first information set comprises N information blocks, the N information blocks respectively comprise channel information for N time units, N being a positive integer greater than 1; an ordering of the N information blocks in the first information set depends on an ordering of the N time units.

In one embodiment, the first communication device 410 comprises at least one processor and at least one memory. The at least one memory comprises computer program codes; the at least one memory and the computer program codes are configured to be used in collaboration with the at least one processor. The first communication device 410 at least: transmits a first configuration information block, the first configuration information block indicates a first resource set; receives a first signal, the first signal carrying a first information set; herein, a target receiver of the first configuration information block performs a first operation, and an input of the first operation depends on a measurement based on the first resource set, and the first information set depends on an output of the first operation; the first information set comprises N information blocks, and the N information blocks each comprise channel information of N time units, N being a positive integer greater than 1; an ordering of the N information blocks in the first information set depends on an ordering of the N time units.

In one embodiment, the first communication device 410 comprises a memory that stores a computer readable instruction program. The computer readable instruction program generates an action when executed by at least one processor. The action includes: transmitting a first configuration information block, the first configuration information block indicating a first resource set; receiving a first signal, the first signal carrying a first information set; herein, a target receiver of the first configuration information block performs a first operation, and an input of the first operation depends on a measurement based on the first resource set, and the first information set depends on an output of the first operation; the first information set comprises N information blocks, and the N information blocks each comprise channel information of N time units, N being a positive integer greater than 1; an ordering of the N information blocks in the first information set depends on an ordering of the N time units.

In one embodiment, the first node comprises the second communication device 450 in the present application.

In one embodiment, the second node in the present application comprises the first communication device 410.

In one embodiment, at least one of the antenna 452, the receiver 454, the receiving processor 456, the multi-antenna receiving processor 458, the controller/processor 459, the memory 460, or the data source 467 is used to receive the first configuration information block; at least one of the antenna 420, the transmitter 418, the transmitting processor 416, the multi-antenna transmitting processor 471, the controller/processor 475, or the memory 476 is used to transmit the first configuration information block.

In one embodiment, at least one of the antenna 452, the receiver 454, the receiving processor 456, the multi-antenna receiving processor 458, the controller/processor 459, the memory 460, or the data source 467 is used to receive a reference signal in the first resource set; at least one of the antenna 420, the transmitter 418, the transmitting processor 416, the multi-antenna transmitting processor 471, the controller/processor 475, or the memory 476 is used to transmit a reference signal in the first resource set.

In one embodiment, at least one of the antenna 420, the receiver 418, the receiving processor 470, the multi-antenna receiving processor 472, the controller/processor 475 or the memory 476 is used to receive the first signal; at least one of the antenna 452, the transmitter 454, the transmitting processor 468, the multi-antenna transmitting processor 457, the controller/processor 459, the memory 460, or the data source 467 is used to transmit the first signal.

### Embodiment 5

Embodiment 5 illustrates a flowchart of a transmission according to one embodiment of the present application, as shown in FIG. 5. In FIG. 5, a second node U1 and a first node U2 are communication nodes transmitted via an air interface. In FIG. 5, each step in block F51 to block F54 is optional.

The second node U1 deploys a second operation in step S5101; transmits a first configuration information block in step S511; transmits a signal in a first resource set in step S5102; and receives a first signal in step S512; performs a second operation in step S5103.

The first node U2 deploys a first operation in step S5201; receives a first configuration information block in step S521; receives a signal in a first resource set in step S5202; performs a first operation in step S522; and transmits a first signal in step S523.

In embodiment 5, the first configuration information block indicates a first resource set; an input of the first operation depends on a measurement based on the first resource set; the first signal carries a first information set, and the first information set depends on an output of the first operation; the first information set comprises N information blocks, the N information blocks respectively comprise channel information for N time units, N being a positive integer greater than 1; an ordering of the N information blocks in the first information set depends on an ordering of the N time units.

In one embodiment, the first node U2 is the first node in the present application.

In one embodiment, the second node U1 is the second node in the present application.

In one embodiment, an air interface between the second node U1 and the first node U2 comprises a radio interface between a base station and a UE.

In one embodiment, an air interface between the second node U1 and the first node U2 comprises a radio interface between a relay node and a UE.

In one embodiment, an air interface between the second node U1 and the first node U2 comprises a radio interface between a UE and a UE.

In one embodiment, the second node U1 is a serving cell maintenance base station of the first node U2.

In one embodiment, the step in the block F52 in FIG. 5 exists.

In one embodiment, in FIG. 5, the step in the block F54 exists, where the first node and the second node adopt a two-sided AI model.

In one embodiment, in FIG. 5, the step in the block F54 does not exist, and the first node adopts a single side AI model.

In one embodiment, in FIG. 5, the step in the block F54 exists, the first operation is used for CSI compression, the second operation is used for CSI recovery, and the first node and the second node adopt a two-sided AI model.

In one embodiment, in FIG. 5, the step in the block F54 does not exist, the first operation is used for beam prediction, and the first node adopts a single side AI model.

In one embodiment, transmitting a signal in a first resource set refers to: transmitting a radio signal in a first resource set.

In one embodiment, transmitting a signal in a first resource set refers to: transmitting a reference signal in a first resource set.

In one embodiment, receiving a signal in a first resource set refers to: receiving a radio signal in a first resource set.

In one embodiment, receiving a signal in a first resource set refers to: receiving a reference signal in a first resource set.

In one embodiment, the deployment of the first operation is earlier than a reception of the first configuration information block.

In one embodiment, the deployment of the first operation is later than a reception of the first configuration information block.

In one embodiment, steps in the block F53 in FIG. 5 exist; the method in a first node for wireless communications comprises: receiving a signal in the first resource set.

In one embodiment, steps in the block F53 in FIG. 5 exist; the method in a second node for wireless communications comprises: transmitting a signal in the first resource set.

In one embodiment, the signal received in the first CSI resource comprises a reference signal.

In one embodiment, the signal received in the first CSI resource comprises a radio signal.

In one embodiment, an output of the first operation comprises a first CSI, the first information set carries the first CSI, and the first CSI serves as an input for a second operation to generate a second CSI.

In one embodiment, the step in the block F51 in FIG. 5 exists, and the above method in a second node for wireless communications comprises: deploying the second operation.

In one embodiment, the deployment of the second operation is earlier than a transmission of the first configuration information block.

In one embodiment, the deployment of the second operation is later than a transmission of the first configuration information block.

In one embodiment, the step in block F54 in FIG. 5 exists, and the above method in a second node for wireless communications comprises: performing the second operation.

In one embodiment, the first operation is used for CSI compression, the second operation is used for CSI recovery, and the first node and the second node adopt a two-sided AI model.

In one embodiment, the first operation is used for beam prediction, and the first node adopts a single side AI model.

In one embodiment, the first resource set comprises at least one RS resource set used for channel measurement, and an RS resource set used for channel measurement comprises one or multiple RS resources; an input of the first operation depends on a measurement based on the first resource set, comprising: an input of the first operation depends on a channel measurement acquired based on the first resource set.

In one embodiment, the first resource set comprises at least one RS resource set used for interference measurement, and an RS resource set used for interference measurement comprises one or multiple RS resources; an input of the first operation depends on a measurement based on the first resource set, comprising: an input of the first operation depends on an interference measurement acquired based on the first resource set.

In one embodiment, the first resource set comprises at least one RS resource set used for channel measurement, and least one RS resource set used for interference measurement; an RS resource set used for channel measurement comprises one or multiple RS resources, and an RS resource set used for interference measurement comprises one or multiple RS resources; an input of the first operation depends on a measurement based on the first resource set, comprising: an input of the first operation depends on a channel measurement and an interference measurement acquired based on the first resource set.

In one embodiment, an input of the first operation depending on a measurement based on the first resource set comprises: a measurement based on the first resource set is used to generate an input for the first operation.

In one embodiment, the first resource set comprises at least one RS resource set used for channel measurement, and an RS resource set used for channel measurement comprises one or multiple RS resources; an input of the first operation depends on a measurement based on the first resource set, comprising: a channel measurement acquired based on the first resource set is used to generate an input for the first operation.

In one embodiment, the first resource set comprises at least one RS resource set used for interference measurement, and an RS resource set used for interference measurement comprises one or multiple RS resources; an input of the first operation depends on a measurement based on the first resource set, comprising: an interference measurement acquired based on the first resource set is used to generate an input for the first operation.

In one embodiment, the first resource set comprises at least one RS resource set used for channel measurement, and least one RS resource set used for interference measurement; an RS resource set used for channel measurement comprises one or multiple RS resources, and an RS resource set used for interference measurement comprises one or multiple RS resources; an input of the first operation depends on a measurement based on the first resource set, comprising: a channel measurement and an interference measurement acquired based on the first resource set are used to generate an input for the first operation.

In one embodiment, a channel measurement acquired based on the first resource set refers to: a channel measurement acquired based on at least one reference signal transmitted from the first resource set.

In one embodiment, a channel measurement acquired based on the first resource set refers to: a channel measurement acquired from the first resource set.

In one embodiment, an interference measurement acquired based on the first resource set refers to: an interference measurement acquired based on at least one reference signal transmitted from the first resource set.

In one embodiment, an interference measurement acquired based on the first resource set refers to: an interference measurement acquired from the first resource set.

In one embodiment, a channel measurement acquired based on the first resource set comprises a channel matrix.

In one embodiment, a channel measurement acquired based on the first resource set comprises a raw channel matrix.

In one embodiment, a channel measurement acquired based on the first resource set comprises an eigenvector.

In one embodiment, a channel measurement acquired based on the first resource set comprises an eigenvector and an eigenvalue.

In one embodiment, a channel measurement acquired based on the first resource set comprises one or more of BLER, delay spread, Doppler spread, Doppler shift, average delay, average gain, path loss, and RSRP.

In one embodiment, an interference measurement acquired based on the first resource set comprises at least one of interference power, interference variance, or interference power spectral density.

In one embodiment, an interference measurement acquired based on the first resource set comprises an interference channel matrix.

In one embodiment, an interference measurement acquired based on the first resource set comprises an interference covariance matrix.

In one embodiment, an interference measurement acquired based on the first resource set comprises an interference eigenvector.

In one embodiment, an interference measurement acquired based on the first resource set comprises an interference eigenvector and interference eigenvalue.

In one embodiment, an interference measurement acquired based on the first resource set comprises an interference beam.

Generally speaking, how the first node determines an input of the first operation based on a measurement of the first resource set is autonomously determined by the device vendor. The following are some non-limiting implementation methods:

In one embodiment, an input of the first operation comprises a channel measurement acquired based on the first resource set.

In one embodiment, an input of the first operation comprises a channel measurement and an interference measurement acquired based on the first resource set.

In one embodiment, an input of the first operation comprises an interference measurement acquired based on the first resource set.

In one embodiment, the interference measurement comprises: one or more of interference power, interference variance, or interference power spectral density.

In one embodiment, an input of the first operation comprises a channel impulse response acquired based on a measurement for the first resource set.

In one embodiment, an input of the first operation comprises a channel matrix acquired based on a measurement for the first resource set.

In one embodiment, an input of the first operation comprises an eigenvector and eigenvalue of a channel matrix acquired based on a measurement for the first resource set.

In one embodiment, an input of the first operation comprises a matrix or vector acquired by pre-processing a channel matrix acquired based on a measurement for the first resource set.

In one embodiment, the channel matrix is in spatial-frequency domain.

In one embodiment, the channel matrix corresponds to angular-delay domain projection.

In one embodiment, the pre-processing comprises one or more of quantization, DFT (Discrete Fourier Transform), matrix decomposition, matrix transformation or projection, spatial to angular domain transformation, angular domain to spatial domain transformation, frequency domain to time domain transformation and time domain to frequency domain transformation, truncation, padding, mapping, or labeling.

In one embodiment, the pre-processing comprises one or more of matrix decomposition, matrix transformation, or projection.

In one embodiment, the pre-processing comprises quantization.

In one embodiment, the pre-processing comprises DFT.

In one embodiment, the pre-processing comprises one or more of quantization, spatial domain to angular domain transformation, angular domain to spatial domain transformation, frequency domain to time domain transformation and time domain to frequency domain transformation.

In one embodiment, the pre-processing comprises truncation and/or padding.

In one embodiment, the pre-processing comprises mapping.

In one embodiment, the pre-processing comprises mapping to vectors.

In one embodiment, the pre-processing comprises labeling.

In one embodiment, the label refers to marking with a label.

In one embodiment, the first information set comprises an output of the first operation.

In one embodiment, the first information set comprises a post-processed output of the first operation.

In one embodiment, the first information set comprises a truncated and/or quantized output of the first operation.

In one embodiment, an output of the first operation is used to generate the first information set.

In one embodiment, an output of the first operation, after undergoing post-processing, is used to generate the first information set.

In one embodiment, an output of the first operation, after undergoing truncation and/or quantization, is used to generate the first information set.

In one embodiment, part or all of an output of the first operation, after undergoing post-processing, is used to generate the first information set.

In one embodiment, part or all of an output of the first operation, after undergoing truncation and/or quantization, is used to generate the first information set.

In one embodiment, the first information set comprises a CSI.

In one embodiment, the first information set comprises predicted channel information.

In one embodiment, the first information set comprises predicted beam information.

In one embodiment, the predicted beam information comprises beam indication and RS resource indication.

In one embodiment, the predicted beam information comprises beam indication and RSRP.

In one embodiment, the predicted beam information comprises RS resource indication and RSRP.

In one embodiment, the predicted beam information comprises one or more of beam indication, CRI (CSI-RS Resource Indicator), SS/PBCH Block Resource Indicator (SSBRI), or RSRP (Reference Signal Received Power).

In one embodiment, the first information set comprises a compress CSI.

In one embodiment, the N time units are orthogonal to each other.

In one embodiment, the N time units are different from each other.

In one embodiment, there exist two time units among the N time units overlapping with each other.

In one embodiment, any one of the N time units comprises a slot.

In one embodiment, any one of the N time units comprises one or multiple slots.

In one embodiment, any one of the N time units comprises a subframe.

In one embodiment, any one of the N time units comprises one or multiple subframes.

In one embodiment, any one of the N time units comprises multiple continuous symbols.

In one embodiment, at least one of the N time units is not earlier than time-domain resources occupied by the first signal.

In one embodiment, at least one of the N time units is later than time-domain resources occupied by the first signal.

In one embodiment, the N time units are continuous.

In one embodiment, the N time units are periodic.

In one embodiment, the N time units are discontinuous.

In one embodiment, the N time units are equally spaced.

In one embodiment, an interval between any two adjacent time units in the N time units is P time unit(s), P being a positive integer.

In one embodiment, an input of the first operation depends on a measurement of reference signal (RS) occasions in the first resource set that are no later than a reference time unit; the N time units are not earlier than or later than the reference time unit.

In one embodiment, an input of the first operation depends on a measurement of RS occasions in the first resource set that are no later than a reference time unit; the N time units are not earlier or later than time-domain resources occupied by the first signal.

In one embodiment, an input of the first operation depends on a measurement of RS occasions in the first resource set that are no later than a reference time unit; the N time units are not earlier than or later than a time unit to which the first signal belongs in time domain.

In one embodiment, CSI reference resources of the first signal belong to the reference time unit in time domain.

In one embodiment, the reference time unit depends on time-domain resources occupied by the first signal.

In one embodiment, the reference time unit depends on a time unit where the first signal is located.

In one embodiment, the reference time unit is earlier than time-domain resources occupied by the first signal.

In one embodiment, the reference time unit is earlier than a time unit where the first signal is located.

In one embodiment, a time unit comprises a slot.

In one embodiment, a time unit comprises a sub-frame.

In one embodiment, a time unit comprises multiple continuous symbols.

In one embodiment, a time unit where the first signal resides is n′, the reference time unit is time unit f(n′), where f(n′) denotes a function.

In one embodiment, a time unit where the first signal is located is n′, the reference time unit is time unit f(n′), the f(n′) is

$$⌊ {n}^{′} \cdot \frac{{2}^{{μ}_{DL}}}{{2}^{{μ}_{UL}}} ⌋ + o ,$$

where μ_{DL} and μ_{UL} are respectively subcarrier spacings of downlink and uplink, o is configurable, and └ ┘ denotes an operation of rounding down to a nearest integer.

In one subembodiment of the above embodiment, the o is

$$⌊ ( \frac{{N}_{slot , offset , UL}^{CA}}{{2}^{{μ}_{offset , UL}}} - \frac{{N}_{slot , offset , DL}^{CA}}{{2}^{{μ}_{offset , DL}}} ) \cdot {2}^{{μ}_{DL}} ⌋ - {n}_{CSI \_ ref} - {K}_{offset} \cdot \frac{{2}^{{μ}_{DL}}}{{2}^{{μ}_{{K}_{offset}}}} ;$$

where K_{offset} is configured by a higher-layer signaling, n_{CSI_ref} is a smallest value not less than

$$4 \cdot {2}^{{μ}_{DL}} , {μ}_{{K}_{offset}} {N}_{slot , offset}^{CA}$$

and μ_{offset} also configured by higher-layer signalings, and for detailed descriptions, refer to Section 5.2.2.5 of 3GPP TS 38.214.

In one embodiment, the symbol is a single carrier symbol.

In one embodiment, the symbol is a multicarrier symbol.

In one embodiment, the symbol is a 6G single carrier symbol.

In one embodiment, the symbol is a 6G multicarrier symbol.

In one embodiment, the multicarrier symbol is an Orthogonal Frequency Division Multiplexing (OFDM) symbol.

In one embodiment, the symbol is acquired after an output of transform precoding undergoing OFDM symbol generation.

In one embodiment, the multicarrier symbol is a Single Carrier-Frequency Division Multiple Access (SC-FDMA) symbol.

In one embodiment, the multicarrier symbol is a Discrete Fourier Transform Spread OFDM (DFT-S-OFDM) symbol.

In one embodiment, the multicarrier symbol is a Filter Bank Multicarrier (FBMC) symbol.

In one embodiment, the multicarrier symbol comprises a Cyclic Prefix (CP).

In one embodiment, any one of the N time units comprises a period of time.

In one embodiment, a duration of the N time units is the same.

In one embodiment, there are two time units with different durations among the N time units.

In one embodiment, a given information block is any one of the N information blocks, the given information block comprises channel information of a given time unit, and the given time unit is a time unit corresponding to the given information block among the N time units.

In one embodiment, the first information set comprises a CSI.

In one embodiment, the N information blocks each comprise predicted channel information for N time units.

In one embodiment, the N information blocks each comprise predicted beam information for N time units.

In one embodiment, any one of the N information blocks indicates at least one resource in a first resource set.

In one embodiment, the first resource set comprises at least one RS resource; any one of the N information blocks indicates at least one RS resource in the first resource set.

In one embodiment, the first resource set comprises at least one beam; any one of the N information blocks indicating at least one resource in a first resource set comprises: any one of the N information blocks indicates at least one beam in the first resource set.

In one embodiment, the first resource set comprises one or more beams; any one of the N information blocks indicates at least one resource in a first resource set comprises: any one of the N information blocks indicates at least one beam in the first resource set.

In one embodiment, the first resource set comprises one or more vectors; any one of the N information blocks indicates at least one resource in a first resource set comprises: any one of the N information blocks indicates at least one vector in the first resource set.

In one embodiment, the first resource set comprises one or more matrixes; any one of the N information blocks indicates at least one resource in a first resource set comprises: any one of the N information blocks indicates at least one matrix in the first resource set.

In one embodiment, the first resource set comprises one or more DFT vectors; any one of the N information blocks indicates at least one resource in a first resource set comprises: any one of the N information blocks indicates at least one DFT vector in the first resource set.

In one embodiment, the first resource set comprises one or more DFT codebooks; any one of the N information blocks indicates at least one resource in a first resource set comprises: any one of the N information blocks indicates at least one codebook in the first resource set.

In one embodiment, the first resource set comprises one or more antenna ports; any one of the N information blocks indicates at least one resource in a first resource set comprises: any one of the N information blocks indicates at least one antenna port in the first resource set.

In one embodiment, the predicted beam information comprises beam indication and RS resource indication.

In one embodiment, the predicted beam information comprises beam indication and RSRP.

In one embodiment, the predicted beam information comprises RS resource indication and RSRP.

In one embodiment, the predicted beam information comprises one or more of beam indication, CRI (CSI-RS Resource Indicator), SS/PBCH Block Resource Indicator (SSBRI), or RSRP (Reference Signal Received Power).

In one embodiment, the N information blocks each comprise compress CSI of N time units.

In one embodiment, the compress CSI is non-codebook based.

In one embodiment, the compress CSI does not fall under a CSI defined in 3GPP Rel-18, nor does it belong to a CSI defined in versions prior to 3GPP Rel-18.

In one embodiment, a target receiver of the compress CSI is unknown to a transmitter of the compress CSI based on channel parameters recovered by the compress CSI.

In one embodiment, the compress CSI is an AI/M L-based based CSI.

In one embodiment, the compress CSI is a Neural Network-based CSI.

In one embodiment, the compress CSI is CNN (Conventional Neural Networks)-based CSI.

### Embodiment 6

Embodiment 6 illustrates a schematic diagram of a first operation according to one embodiment of the present application, as shown in FIG. 6. In embodiment 6, the first operation is training-based or AI-based.

In one embodiment, a measurement based on the first resource set comprises pre-compressed channel information, and an output of the first operation comprises compressed channel information.

In one embodiment, advantages of the above method include being suitable for channel compression and saving feedback overhead.

In one embodiment, a measurement based on the first resource set comprises channel information acquired from measurement, and an output of the first operation comprises predicted channel information.

In one embodiment, a measurement based on the first resource set comprises channel information acquired from measurement, and an output of the first operation comprises spatial beam prediction.

In one embodiment, a measurement based on the first resource set comprises channel information acquired from measurement, and an output of the first operation comprises a spatial beam prediction for a second resource set.

In one embodiment, resources in the second resource set comprise at least one of antenna ports, time-frequency resources, time-frequency code resources, beams, RS resources, vectors, or matrices.

In one embodiment, advantages of the above approach include reducing RS overhead and reducing feedback delay.

In one embodiment, the channel information in the present application comprises beam information.

In one embodiment, a measurement based on the first resource set comprises current channel information, and an output of the first operation comprises predicted channel information.

In one embodiment, a measurement based on the first resource set comprises historic channel information, and an output of the first operation comprises predicted channel information.

In one embodiment, a measurement based on the first resource set comprises historic channel information, and an output of the first operation comprises a temporal beam prediction.

In one embodiment, a measurement based on the first resource set comprises historic channel information, and an output of the first operation comprises a temporal beam prediction for the second resource set.

In one embodiment, advantages of the above methods include reducing the delay of channel information feedback and improving the real-time performance of channel information acquisition.

In one embodiment, a measurement based on the first resource set comprises current channel information, and an output of the first operation comprises channel information after a period of time.

In one embodiment, a measurement based on the first resource set comprises current channel information, and an output of the first operation comprises future channel information.

In one embodiment, a measurement based on the first resource set comprises historic channel information, and an output of the first operation comprises future channel information.

In one embodiment, advantages of the above methods include improving the accuracy and real-time performance of CSI, and reducing the RS overhead.

In one embodiment, a measurement based on the first resource set comprises incomplete channel information, and an output of the first operation comprises complete channel information.

In one embodiment, advantages of the above approach include reducing the RS overhead and improving the accuracy and completeness of CSI.

In one embodiment, a measurement based on the first resource set comprises channel information of P1 antenna ports, and an output of the first operation comprises channel information of P2 antenna ports, P1 and P2 being positive integers greater than 1, P1 being less than P2.

In one subembodiment of the above embodiment, the P1 antenna ports are a true subset of the P2 antenna ports.

In one subembodiment of the above embodiment, the P2 antenna ports belong to the second resource set.

In one embodiment, a measurement based on the first resource set comprises channel information of a first frequency-domain resource, and an output of the first operation comprises channel information of a second frequency-domain resource, and the second frequency-domain resource comprises frequency-domain resources not belonging to the first frequency-domain resource.

In one subembodiment of the above embodiment, the first frequency-domain resource is a true subset of the second frequency-domain resource.

In one embodiment, the first operation is training-based.

In one embodiment, the first operation is acquired through training.

In one embodiment, the training used to acquire the first operation is performed by the first node.

In one embodiment, the training used for acquiring the first operation is performed by a transmitter of the first configuration information block.

In one embodiment, the training used for acquiring the first operation is performed by a transmitter of the first resource set.

In one embodiment, the training used for acquiring the first operation is performed by the MDA Function (Management Data Analytics Function).

In one embodiment, the training used for acquiring the first operation is performed by the MDAS (Management Data Analytics Service) producer.

In one embodiment, the training used for acquiring the first operation is performed by the Network Data Analytics Function (NWDAF).

In one embodiment, the training used for acquiring the first operation is performed by the core network.

In one embodiment, the training used for acquiring the first operation is performed by the AI training producer.

In one embodiment, a performer used for acquiring the training for the first operation is different from a transmitter of the first configuration information block.

In one embodiment, a performer used for acquiring the training for the first operation is different from a transmitter of the first resource set.

In one embodiment, the first operation comprises inference.

In one embodiment, the first operation comprises AI (Artificial Intelligence).

In one embodiment, the first operation is inference.

In one embodiment, the first operation is AI inference.

In one embodiment, the first operation comprises AI inference used for CSI.

In one embodiment, the first operation comprises AI inference used for beam prediction.

In one embodiment, advantages of the above methods include improving the performance of CSI

(including beams) measurement and reporting, including more accurate CSI as well as lower reference signal overhead and reporting overhead, thereby improving the overall performance of the system.

In one embodiment, the first operation is an AI inference used for CSI.

In one embodiment, the first operation comprises AI inference used for at least one of beam prediction, CSI prediction, CSI evaluation, or CSI compression.

In one embodiment, the CSI prediction comprises beam prediction.

In one embodiment, advantages of the above methods include more accurate and complete CSI, lower reference signal overhead, and improved real-time performance of CSI.

In one embodiment, the first operation is based on an AI model.

In one embodiment, the first operation comprises an AI entity.

In one embodiment, the first operation comprises an AI inference entity.

In one embodiment, the first operation comprises an AI entity used for inference.

In one embodiment, the first operation comprises a part of an AI entity.

In one embodiment, the first operation comprises a part of an AI entity used for inference.

In one embodiment, the first operation comprises an AI entity used for CSI.

In one embodiment, the first operation comprises an AI entity used for beam prediction.

In one embodiment, the first operation comprises an AI entity used for CSI prediction, evaluation, or compression.

In one embodiment, the first operation comprises an inference of an AI entity used for CSI.

In one embodiment, the first operation comprises an inference of an AI entity used for CSI prediction, evaluation, or compression.

In one embodiment, the first operation is performed by an AI entity.

In one embodiment, the first operation is performed by an AI entity deployed on the first node.

In one embodiment, the first operation is performed by an AI function.

In one embodiment, the first operation is performed by an AI function deployed on the first node.

In one embodiment, the AI function comprises an AI inference function.

In one embodiment, the AI function comprises an AI training function.

In one embodiment, the AI function comprises an AI management function.

In one embodiment, the first operation is performed by the physical layer of the first node.

In one embodiment, the first operation is performed by the higher layer of the first node.

In one embodiment, the first operation requires deployment.

In one embodiment, the first operation is acquired through loading.

In one embodiment, the first operation is acquired by loading from a serving cell of the first node.

In one embodiment, the first operation is acquired by loading from a maintenance base station of a serving cell of the first node.

In one embodiment, the first operation is acquired by loading from the core network.

In one embodiment, the first operation is AI/ML-based.

In one embodiment, the first operation is based on the neural network.

In one embodiment, the first operation comprises a CSI compression based on the neural network.

In one embodiment, the first operation comprises an encoder for CSI compression based on the neural network.

In one embodiment, the first operation comprises CNN-based CSI compression.

In one embodiment, the first function comprises a CNN-based encoder for CSI compression.

In one embodiment, an output of the first operation is non-codebook based.

In one embodiment, an output of the first operation does not belong to a CSI defined by 3GPP Rel-18, nor does it belong to a CSI defined by versions prior to 3GPP Rel-18.

In one embodiment, an output of the first operation is AI/ML-based.

In one embodiment, an output of the first operation is based on the neural network.

In one embodiment, an output of the first operation is CNN-based.

In one embodiment, an output of the first operation comprises CSI.

In one embodiment, an output of the first operation comprises predicted beam information.

In one embodiment, an output of the first operation comprises beam indication and RSRP.

In one embodiment, an output of the first operation comprises RS resource indication and RSRP.

In one embodiment, an output of the first operation comprises resource indication and RSRP.

In one embodiment, an output of the first operation comprises one or more of beam indication, CRI (CSI-RS Resource Indicator), SS/PBCH Block Resource Indicator (SSBRI), or RSRP (Reference Signal Received Power).

In one embodiment, an output of the first operation comprises one or more of PMI, CRI, CQI, RI, LI, SSBRI, RSRP, SINR, capability Index, and TDCP.

In one embodiment, an output of the first operation comprises channel impulse response.

In one embodiment, an output of the first operation comprises small-scale properties.

In one embodiment, an output of the first operation comprises one or more of delay spread, Doppler extension, Doppler shift, average delay and average gain.

In one embodiment, an output of the first operation comprises channel matrix.

In one embodiment, an output of the first operation comprises a first CSI.

In one embodiment, the first CSI comprises predicted/or estimated CSI.

In one embodiment, the first CSI comprises predicted beam information.

In one embodiment, in the above method, the first operation is used for beam prediction, CSI prediction, or evaluation to reduce the RS overhead and/or improve CSI accuracy/completeness.

In one embodiment, the first node is a consumer.

In one embodiment, the first node is a consumer of the AI function.

In one embodiment, the first node is a consumer of the AI inference.

In one embodiment, the first node is a consumer of the AI training.

In one embodiment, the first node is a Management Service (MnS) consumer.

In one embodiment, the first node is a producer of the AI inference.

In one embodiment, the first node is a producer of the AI training.

In one embodiment, the first operation comprises pre-processing.

In one embodiment, the pre-processing comprises DFT (Discrete Fourier Transform).

In one embodiment, the pre-processing comprises one or more of matrix decomposition, matrix transformation, and projection.

In one embodiment, the pre-processing comprises one or more of quantization, spatial domain to angular domain transformation, angular domain to spatial domain transformation, frequency domain to time domain transformation and time domain to frequency domain transformation.

In one embodiment, the pre-processing comprises truncation and/or padding.

In one embodiment, the pre-processing comprises mapping.

In one embodiment, the pre-processing comprises mapping to vectors.

In one embodiment, the pre-processing comprises labeling.

In one embodiment, the labeling refers to marking with a label.

In one embodiment, the first operation comprises post-processing.

In one embodiment, the post-processing comprises DFT.

In one embodiment, the post-processing comprises quantization.

In one embodiment, the post-processing includes one or more of angle domain to spatial domain transformation, spatial domain to angle domain transformation, time domain to frequency domain transformation, and frequency domain to time domain transformation.

In one embodiment, the post-processing comprises truncation and/or padding.

In one embodiment, the first operation includes one or more of convolution, pooling, cascading, and activation.

In one embodiment, the first operation comprises a fully-connected layer.

In one embodiment, the first operation comprises a pooling layer.

In one embodiment, the first operation comprises at least one convolutional layer.

In one embodiment, the first operation comprises at least one encoding layer.

In one embodiment, an encoding layer comprise at least one convolutional layer and one pooling layer.

In one embodiment, at the convolutional layer, at least one convolutional kernel is used to convolve an input to generate a corresponding feature map, and the at least one feature map output from the convolutional layer is reshaped into a vector to be input to the fully-connected layer; the fully-connected layer converts the vector into an output.

In one embodiment, part or all of the convolution kernel size, number of convolution layers, convolution step-size, pooling kernel size, pooling kernel step-size, pooling function, activation function, and feature map quantity of the first operation are acquired through training.

In one embodiment, part or all of the convolution kernel, pooling kernel, pooling function, activation function, and parameters of the pooling function and parameters of the activation function in the first operation are acquired through training.

### Embodiment 7

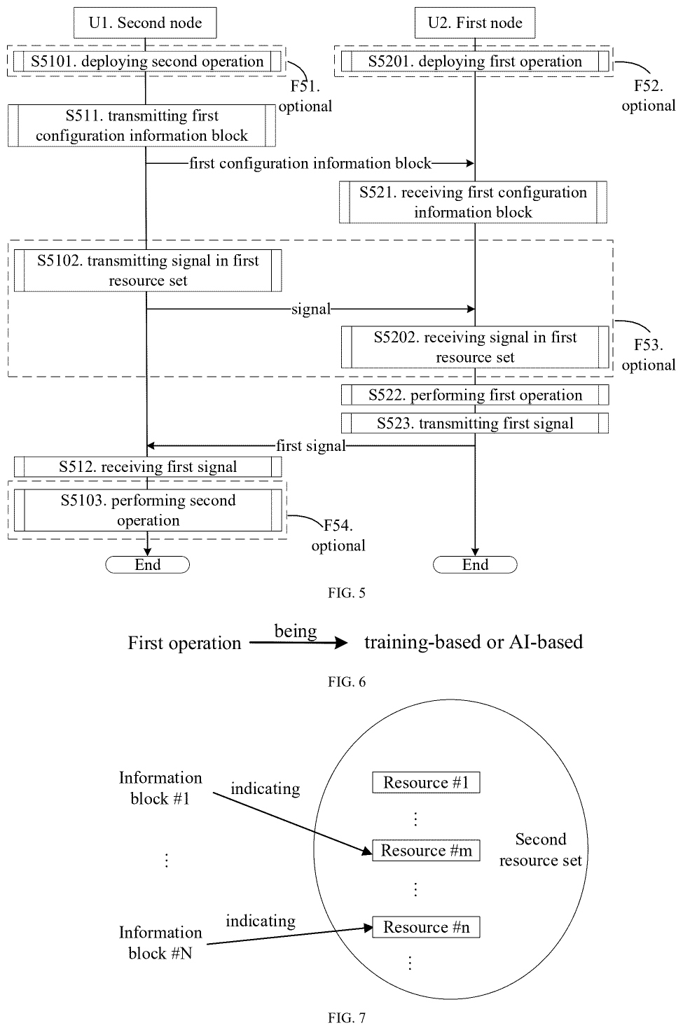

Embodiment 7 illustrates a schematic diagram of a second resource set according to one embodiment of the present application, as shown in FIG. 7. In FIG. 7, information blocks #1, . . . , #N represent N information blocks; resources #1, . . . , #m, . . . , #n, . . . denote resources in a second resource set.

In embodiment 7, any one of the N information blocks indicates at least one resource in a second resource set, and the second resource set comprises resources not belonging to the first resource set.

In one embodiment, the first node is not required to measure the second resource set.

In one embodiment, the first resource set is used for measurement, and the second resource set is used for prediction.

In one embodiment, the first resource set is used for measurement, and the second resource set is used for prediction.

In one embodiment, only the first resource set of the first resource set and the second resource set are used for a measurement.

In one embodiment, only the first resource set of the first resource set and the second resource set are used for a measurement, comprising: only the first resource set from the first resource set and the second resource set is used for a measurement by the first node.

In one embodiment, only the first resource set of the first resource set and the second resource set are used for a measurement, comprising: the first resource set is used by the first node for measurement, and the first node is not required to measure the second resource set.

In one embodiment, the first operation performs a spatial beam prediction for a second resource set based on a measurement for the first resource set.

In one embodiment, advantages of the above approach include reducing the RS overhead and reducing the feedback delay.

In one embodiment, the first operation performs a channel information prediction for a second resource set based on a measurement for the first resource set.

In one embodiment, the channel information in the present application comprises beam information.

In one embodiment, the first operation performs a temporal beam prediction for a second resource set based on a historic measurement of the first resource set.

In one embodiment, advantages of the above methods include reducing the beam feedback delay and improving the real-time performance of beam acquisition.

In one embodiment, the first operation performs a temporal channel information prediction for a second resource set based on a historic measurement of the first resource set.

In one embodiment, advantages of the above methods include reducing the delay of channel information feedback and improving the real-time performance of channel information acquisition.

In one embodiment, the second resource set comprises the first resource set and resources outside of the first resource set.

In one embodiment, the first resource set comprises one or multiple RS resources, the second resource set comprises one or multiple RS resources, and the second resource set comprises both the first resource set and RS resources other than the first resource set.

In one embodiment, a number of resources comprised in the first resource set is less than a number of resources comprised in the second resource set.

In one embodiment, a number of RS resources comprised in the first resource set is smaller than a number of RS resources comprised in the second resource set.

In one embodiment, the second resource set comprises resources that do not belong to the first resource set.

In one embodiment, the second resource set comprises antenna ports that do not belong to the first resource set.

In one embodiment, the second resource set comprises resources that do not belong to the first resource set, and resources in the second resource set comprise at least one of antenna ports, TCI status, QCL information, time-frequency resources, time-frequency code resources, beams, RS resources, vectors, or matrices.

In one embodiment, the second resource set comprises at least one RS resource; any one of the N information blocks indicates at least one RS resource in the second resource set.

In one embodiment, the second resource set comprises at least one beam; any one of the N information blocks indicates at least one resource in a second resource set, comprising: any one of the N information blocks indicates at least one beam in the second resource set.

In one embodiment, the second resource set comprises one or more beams; any one of the N information blocks indicates at least one resource in a second resource set, comprising: any one of the N information blocks indicates at least one beam in the second resource set.

In one embodiment, the second resource set comprises one or more vectors; any one of the N information blocks indicates at least one resource in a second resource set, comprising: any one of the N information blocks indicates at least one vector in the second resource set.

In one embodiment, the second resource set comprises one or more matrixes; any one of the N information blocks indicates at least one resource in a second resource set, comprising: any one of the N information blocks indicates at least one matrix in the second resource set.

In one embodiment, the second resource set comprises one or more DFT vectors; any one of the N information blocks indicates at least one resource in a second resource set, comprising: any one of the N information blocks indicates at least one DFT vector in the second resource set.

In one embodiment, the second resource set comprises one or more DFT codebooks; any one of the N information blocks indicates at least one resource in a second resource set, comprising: any one of the N information blocks indicates at least one codebook in the second resource set.

In one embodiment, the second resource set comprises one or more antenna ports; any one of the N information blocks indicates at least one resource in a second resource set, comprising: any one of the N information blocks indicates at least one antenna port in the second resource set.

In one embodiment, the second resource set comprises at least one training dataset.

In one embodiment, the second resource set is used to train an AI model.

In one embodiment, the second resource set comprises one or more RS (Reference Signal) resource sets, one RS resource set comprising one or multiple RS resources.

In one embodiment, the second resource set comprises at least one of at least one CSI-RS resource set, at least one CSI-SSB (Channel State Information-Synchronization Signal Block) resource set, or at least one CSI-IM (Channel State Information-Interference Measurement) resource set.

In one embodiment, the second resource set comprises at least one RS resource set used for channel measurement, and an RS resource set used for channel measurement comprises one or multiple RS resources.

In one embodiment, the second resource set comprises at least one RS resource set used for channel measurement, and least one RS resource set used for interference measurement; an RS resource set used for channel measurement comprises one or multiple RS resources, and an RS resource set used for interference measurement comprises one or multiple RS resources.

In one embodiment, the second resource set comprises at least one RS resource set used for interference measurement; an RS resource set used for interference measurement comprises one or multiple RS resources.

In one embodiment, the second resource set comprises one or multiple RS resources.

In one embodiment, the second resource set comprises one or more downlink RS resources.

In one embodiment, the second resource set comprises one or multiple RS resources, and any RS resource in the second resource set is a CSI-RS (Channel State Information Reference Signal) resource or a synchronization signal resource.

In one embodiment, the first configuration information block indicates at least one resource configuration, and the at least one resource configuration indicates the second resource set.

In one embodiment, the first configuration information block comprises at least one resource configuration, and the at least one resource configuration indicates the second resource set.

In one embodiment, the first configuration information block indicates at least one resource configuration, and the at least one resource configuration indicates the first resource set and the second resource set.

In one embodiment, the first configuration information block comprises at least resource configuration, and the at least one resource configuration indicates the first resource set and the second resource set.

In one embodiment, the first configuration information block indicates a resource configuration, and the resource configuration indicates the first resource set and the second resource set.

In one embodiment, the first configuration information block indicates two resource configurations, and the two resource configurations respectively indicating the first resource set and the second resource set.

In one embodiment, the first configuration information block indicates configuration information of the second resource set.

In one embodiment, the first configuration information block indicates an identifier of the second resource set.

In one embodiment, the first configuration information block is used to indicate the second resource set from a reference resource set.

In one embodiment, the first configuration information block indicates a first identifier, and the second resource set depends on the first identifier.

In one embodiment, the second resource set depending on the first identifier includes: the first identifier is used to identify the second resource set.

In one embodiment, the second resource set depending on the first identifier includes: the first identifier is used to identify a reference resource set, and the reference resource set comprises the second resource set.

In one embodiment, the second resource set depending on the first identifier includes: the first identifier is used to identify a reference resource set, the reference resource set comprises the second resource set, and the first configuration information block is used to indicate the second resource set from the reference resource set.

In one embodiment, an input of the first operation also comprises the second resource set.

### Embodiment 8

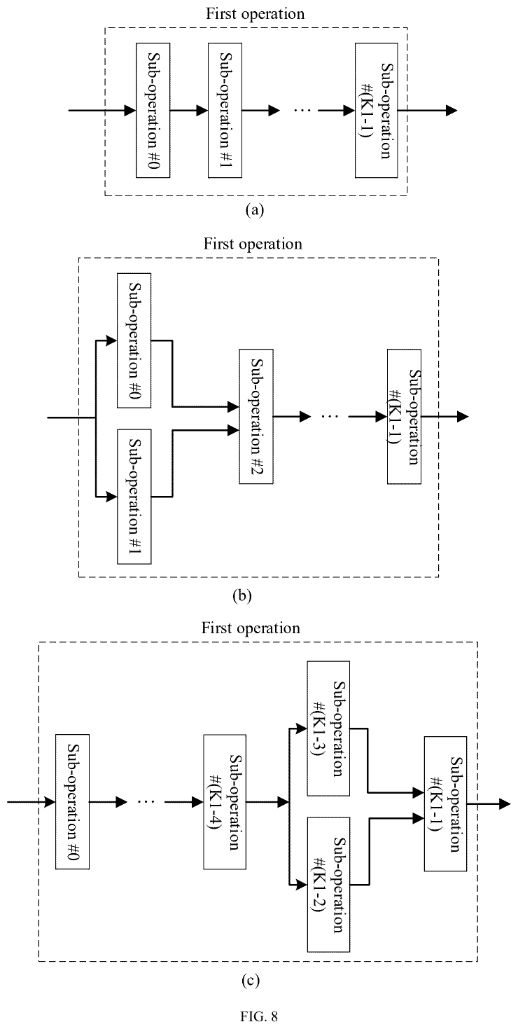

Embodiment 8 illustrates a schematic diagram of a first operation according to another embodiment of the present application, as shown in FIG. 8. In embodiment 8, the first operation comprises K1 sub-operation(s), K1 being a positive integer not greater than 1. In FIG. 8, the K1 sub-operation(s) is (are respectively) denoted as sub-operation #0, . . . , sub-operation #(K1-1).

In one embodiment, each sub-operation in the K1 sub-operation(s) is training-based.

In one embodiment, at least one sub-operation in the K1 sub-operation(s) is training-based.

In one embodiment, a performer of training each training-based sub-operation in the K1 sub-operation(s) is based is the same.

In one embodiment, performers of training two sub-operations in the K1 sub-operations are based are different.

In one embodiment, at least one sub-operation in the K1 sub-operation(s) needs to be deployed.

In one embodiment, at least one sub-operation in the K1 sub-operation(s) needs to be loaded.

In one embodiment, all sub-operation(s) that need to be loaded in the K1 sub-operation(s) is (are) loaded from a same producer.

In one embodiment, two sub-operations that need to be loaded in the K1 sub-operations are loaded from different producers.

In one embodiment, at least one sub-operation in the K1 sub-operation(s) is not training-based.

In one embodiment, at least one of the K1 sub-operation(s) is based on codebook defined for precoding in 3GPP R18 or versions prior to 3GPP R18.

In one embodiment, one or more of the K1 sub-operations are AI-based.

In one embodiment, one or more sub-operations in the K1 sub-operations comprise inference.

In one embodiment, one or more sub-operations in the K1 sub-operations comprise AI inference.

In one embodiment, one or more sub-operations in the K1 sub-operations comprise AI inference used for CSI.

In one embodiment, the AI (Artificial Intelligence) comprises Machine Learning (ML).

In one embodiment, one or more of the K1 sub-operations comprise pre-processing.

In one embodiment, one or more of the K1 sub-operations comprise post-processing.

In one embodiment, there are two sub-operations in the K1 sub-operations that are serial, such as all sub-operations in FIG. 8(a), sub-operations #2 to #(K1-1) in FIG. 8(b), and sub-operations #0 to #(K1-4) in FIG. 8(c).

In one embodiment, two sub-operations are serial, which means that an output of one of the two sub-operations is used as an input of the other one of the two sub-operations.

In one embodiment, there are two sub-operations in the K1 sub-operations being parallel, such as sub-operation #0 and sub-operation #1 in FIG. 8(b), and sub-operation #(K1-3) and sub-operation #(K1-2) in FIG. 8(c).

In one embodiment, two sub-operations are parallel, which means that outputs of the two sub-operations are used together as an input for another sub-operation.

In one embodiment, the K1 sub-operation comprises one or more of convolution, pooling, cascading or activation.

In one embodiment, there exists one of the K1 sub-operations comprising a fully-connected layer.

In one embodiment, there exists one of the K1 sub-operations comprising a pooling layer.

In one embodiment, there exists one of the K1 sub-operations comprising at least one convolutional layer.

In one embodiment, there exists one of the K1 sub-operations comprising at least one encoding layer.

In one embodiment, there exist two sub-operations in the K1 sub-operations respectively comprising a fully-connected layer and at least one encoding layer.

In one embodiment, an encoding layer comprise at least one convolutional layer and one pooling layer.

### Embodiment 9

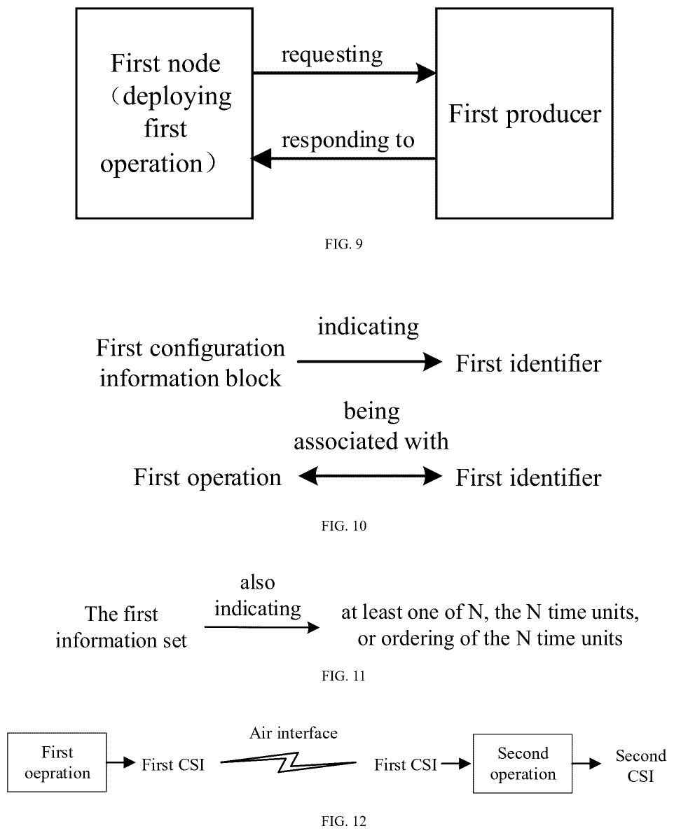

Embodiment 9 illustrate a schematic diagram of the first node deploying the first operation according to one embodiment of the present application, as shown in FIG. 9.

In one embodiment, the deployment comprises acquiring the first operation.

In one embodiment, the deployment comprises acquiring an AI entity.

In one embodiment, the deployment comprises acquiring an AI entity to perform the first operation.

In one embodiment, the deployment comprises acquiring an AI entity that comprises the AI function to perform the first operation.

In one embodiment, the deployment comprises loading the first operation.

In one embodiment, the deployment comprises requesting to load the first operation.

In one embodiment, the request in FIG. 9 is a request from the first node to load the first operation.

In one embodiment, the response in FIG. 9 is a response to the request made by the first node to load the first operation.

In one embodiment, the first node acquires the first operation through the response in FIG. 9.

In one embodiment, the first operation is acquired by loading from a serving cell of the first node.

In one embodiment, the first operation is acquired by loading from a maintenance base station of a serving cell of the first node.

In one embodiment, the first operation is acquired by loading from the core network.

In one embodiment, the first operation is acquired by loading from a first producer.

In one embodiment, the first producer provides the first operation to the first node through the response in FIG. 9.

In one embodiment, the deployment is completed by the AI function.

In one embodiment, the deployment is completed by the AI function deployed on the first node.

In one embodiment, the deployment is completed by the AI deployment function.

In one embodiment, the deployment is completed by the AI deployment function deployed on the first node.

In one embodiment, the deployment is completed by the AI inference function.

In one embodiment, the deployment is completed by the AI inference functions deployed on the first node.

In one embodiment, the deployment is completed by the AI entity.

In one embodiment, the deployment is completed by the AI entity deployed on the first node.

In one embodiment, the deployment is completed by an AI entity with deployment function.

In one embodiment, the deployment is completed by an AI entity with deployment function deployed on the first node.

In one embodiment, the deployment is completed by an AI entity with inference function.

In one embodiment, the deployment is completed by an AI entity with inference function deployed on the first node.

In one embodiment, the deployment comprises acquiring the first operation from a first producer.

In one embodiment, the deployment comprises requesting a first producer to load the first operation.

In one embodiment, the deployment comprises loading the first operation from the first producer.

In one embodiment, the first producer generates and provides AI entities.

In one embodiment, the first producer generates and provides AI functions.

In one embodiment, the first producer is a producer of the first operation.

In one embodiment, the first producer comprises an AI entity producer.

In one embodiment, the first producer comprises an AI function producer.

In one embodiment, the first producer comprises an AI deployment producer.

In one embodiment, the first producer comprises an AI loading producer.

In one embodiment, the first producer comprises an AI training producer.

In one embodiment, the first producer comprises an AI inference producer.

In one embodiment, the first producer comprises a producer for deployment of the AI entities.

In one embodiment, the first producer comprises a producer for loading of AI entities.

In one embodiment, the first producer comprises an MnS (Management Service) producer.

In one embodiment, a transmitter of the first configuration information block is the first producer.

In one embodiment, a transmitter of the first configuration information block is different from the first producer.

In one embodiment, training used to acquire the first operation is performed by the first producer.

In one embodiment, a performer used to acquire the training for the first operation is different from the first producer.

In one embodiment, the AI comprises Machine Learning (ML).

### Embodiment 10

Embodiment 10 illustrates a schematic diagram of a first identifier according to one embodiment of the present application, as shown in FIG. 10. In embodiment 10, the first configuration information block indicates a first identifier, and the first operation is associated with the first identifier.

In one embodiment, the first identifier is a non-negative integer.

In one embodiment, the first identifier is a character string.

In one embodiment, the first operation is identified by the first identifier.

In one embodiment, an AI model adopted by the first operation is identified by the first identifier.

In one embodiment, an AI entity to which the first operation belongs is identified by the first identifier.

In one embodiment, an AI function to which the first operation belongs is identified by the first identifier.

In one embodiment, an AI entity or AI function to which the first operation belongs is identified by the first identifier.

In one embodiment, advantages of the above method include identifying an AI entity or function through the first identifier, simplifying the design, and unifying the understanding of different AI entities or functions across multiple nodes.

In one embodiment, an AI function that performs the first operation is identified by the first identifier. In one embodiment, an AI entity that performs the first operation is identified by the first identifier.

In one embodiment, an AI entity or AI function performing the first operation is identified by the first identifier.

In one embodiment, the first identifier is a model identifier.

In one embodiment, the first identifier is used to identify an AI model.

In one embodiment, the first identifier is used by the first node to determine an AI model.

In one embodiment, the first identifier is used by the first node to determine an AI model adopted by the first operation.

In one embodiment, advantages of the above method include identifying an AI model/entity/function through the first identifier, simplifying the design, and unifying the understanding of different AI entities/functions across multiple nodes.

In one embodiment, the first identifier is used to identify or indicate a reference resource set, and a measurement for the reference resource set is used to acquire a training dataset for the first operation.

In one embodiment, the first identifier is used to identify configuration information of a reference resource set, and a measurement for the reference resource set is used to acquire a training dataset for the first operation.

In one embodiment, the training used to acquire the first operation is identified by the first identifier.

In one embodiment, a dataset used for the training the first operation is identified by the first identifier.

In one embodiment, advantages of the above method include by identifying an AI training process or AI training dataset, it enables the recognition of inferences generated from them, establishing consensus among different AI functions, and further simplifying the system design.

In one embodiment, the first configuration information block indicates the first operation by indicating the first identifier.

In one embodiment, the first configuration information block indicates the use of the AI model by indicating the first identifier.

In one embodiment, the first configuration information block acquires an input associated with an AI entity/function/inference associated with the first identifier by indicating the first identifier.

In one embodiment, the first operation performs a spatial beam prediction for a second resource set based on a measurement for the first resource set, and the second resource set depends on the first identifier.

In one embodiment, advantages of the above method include reducing the RS overhead and reducing the feedback delay.

In one embodiment, the first operation performs a channel information prediction for a second resource set based on a measurement for the first resource set, and the second resource set depends on the first identifier.

In one embodiment, the channel information in the present application comprises beam information.

In one embodiment, the first operation performs a temporal beam prediction for a second resource set based on a historic measurement of the first resource set, and the second resource set depends on the first identifier.

In one embodiment, advantages of the above methods include reducing the beam feedback delay and improving the real-time performance of beam acquisition.

In one embodiment, the first operation performs a temporal channel information prediction for a second resource set based on a historic measurement of the first resource set, and the second resource set depends on the first identifier.

In one embodiment, advantages of the above methods include reducing the channel information feedback delay and improving the real-time performance of channel information acquisition.

### Embodiment 11

Embodiment 11 illustrates a schematic diagram of a first information set according to one embodiment of the present application, as shown in FIG. 11. In embodiment 11, the first information set also indicates at least one of N, the N time units, or an ordering of the N time units.

In one embodiment, the first information set also indicates which time units the N time units are in a first time unit set, and the first time unit set comprises multiple time units.

In one embodiment, the first information set also indicates a position of the N time units in a first time unit set, and the first time unit set comprises multiple time units.

In one embodiment, the first information set also indicates indices of the N time units.

In one embodiment, an ordering of the N time units is performed or determined in the first operation.

In one embodiment, an ordering of the N time units is autonomously determined by the first node.

In one embodiment, an ordering of the N time units is reported by the first node to a transmitter of the first configuration information block.

In one embodiment, an information block in the first information set indicates the N.

In one embodiment, the first information set comprises an information block indicating an ordering of the N time units.

In one embodiment, a first one of the N information blocks also indicates an ordering of the N time units.

In one embodiment, one of the N information blocks also indicates an ordering of the N time units.

In one embodiment, a first one of information blocks in the first information set also indicates an ordering of the N time units.

In the above method, at least one of N, the N time units, or an ordering of N time units is determined by the first node and reported to a transmitter of the first configuration information block, giving the first node sufficient flexibility to adapt to various different scenarios and terminals, offering good adaptability and flexibility, improving the performance of CSI reporting, achieving more accurate reporting and reduced overhead.

In one embodiment, the first node determines that the N time units are time units spaced at an interval of Q time units in a first time unit set, the first time unit set comprising more than N time units, Q being a positive integer; the first information set also indicates Q.

In general, the determination of at least one of N, the N time units, or an ordering of the N time units by the first node may be autonomously determined by the hardware equipment vendor. The following describes some non-limiting implementation aspects:

In one embodiment, the first node determines that the N time units are time units spaced at an interval of Q time units in a first time unit set, Q being a positive integer; Q is determined by the first node based on at least one of channel changes, channel temporal correlation, or movement speed.

In one embodiment, the first node determines the N time units based on changes in channels in the first time unit set.

In one embodiment, the first node determines the N time units based on time correlation in channels in the first time unit set.

In one embodiment, the first node determines that the N time units are time units with fast channel changes (such as changes greater than a threshold).

In one embodiment, the first node determines the N time units based on its movement speed.

In one embodiment, the first node determines that the N time units are time units with lower time correlation (such as below a threshold).

### Embodiment 12

Embodiment 12 illustrates a schematic diagram of a first CSI and a second CSI according to one embodiment of the present application, as shown in FIG. 12. In embodiment 12, an output of the first operation comprises a first CSI, the first information set carries the first CSI, the first CSI serves as an input of a second operation by a target receiver of the first information set to generate a second CSI.

In one embodiment, the first operation is used for CSI compression and the second operation is used for CSI recovery, and the first node and the second node adopt a two-sided AI model.

In one embodiment, the first CSI comprises N sub-CSIs, and the N information blocks each carry the N sub-CSIs.

In one embodiment, the first CSI comprises an output of the first operation.

In one embodiment, the first CSI comprises a compress CSI.

In one embodiment, the second CSI comprises recovery of at least a part of an input of the first operation.

In one embodiment, the second CSI comprises one or more of PMI (Precoding Matrix Indicator), CRI (CSI-RS Resource Indicator), SS/PBCH Block Resource indicator (SSBRI), beam indicator, resource Indicator, CQI (Channel quality indicator), RI (Rank Indicator), Layer Indicator (L1), RSRP (reference signal received power), SINR (signal-to-noise and interference ratio), Capability Index, or TDCP (Time Domain Channel Properties).

In one embodiment, the second CSI comprises a channel matrix.

In one embodiment, the second CSI comprises an eigenvector and/or an eigenvalue.

In one embodiment, the second CSI comprises a precoding matrix.

In one embodiment, the second CSI comprises one or more of channel matrix, eigenvector, eigenvalue, or precoding matrix.

In one embodiment, the target receiver of the first information set is a transmitter of the first configuration information block.

In one embodiment, the target receiver of the first information set is a transmitter of the first resource set.

In one embodiment, the second operation is an inverse operation of the first operation.

In one embodiment, the second operation is training-based.

In one embodiment, training used for acquiring the second operation is performed by the target receiver of the first information set.

In one embodiment, the training used for acquiring the second operation is performed by the MDA function.

In one embodiment, the training used for acquiring the second operation is performed by the MDAS producer.

In one embodiment, the training used for acquiring the second operation is performed by NWDAF.

In one embodiment, the training used for acquiring the second operation is performed by the core network.

In one embodiment, the training used for acquiring the second operation is performed by an AI (Artificial Intelligence) training producer.

In one embodiment, the AI comprises Machine Learning (ML).

In one embodiment, the AI comprises the neural network.

In one embodiment, the AI comprises Conventional Neural Networks (CNN).

In one embodiment, the first operation and the second operation are acquired through different trainings.

In one embodiment, the first operation and the second operation are acquired through independent training.

In one embodiment, advantages of the above method comprise: saving air interface overhead, having better flexibility, being able to adapt to different terminals, and having better forward compatibility.

In one embodiment, the first operation and the second operation are acquired through joint training.

In one embodiment, advantages of the above method comprise: optimizing performance.

In one embodiment, training of the second operation depends on the first operation.

In one embodiment, a producer of the second operation trains the second operation according to an output of the first operation.

In one embodiment, the second operation comprises inference.

In one embodiment, the second operation comprises AI inference.

In one embodiment, the second operation comprises AI inference for CSI.

In one embodiment, the second operation is AI inference for CSI recovery.

In one embodiment, the second operation is AI inference for CSI decompression.

In one embodiment, the second operation is performed by an AI entity deployed on the second node in the present application.

In one embodiment, the second operation is performed by an AI function deployed on the second node in the present application.

In one embodiment, the second operation requires deployment.

In one embodiment, the second operation is acquired through loading.

In one embodiment, the second operation is acquired by loading from the core network.

In one embodiment, the second operation is acquired by loading from a producer.

In one embodiment, the second operation is acquired by loading from a producer of the second operation.

In one embodiment, the second operation is acquired by loading from an AI entity producer.

In one embodiment, the second operation is acquired by loading from an AI function producer.

In one embodiment, the second operation is acquired by loading from an MnS producer.

In one embodiment, the second operation is AI/ML-based.

In one embodiment, the second operation is based on the neural network.

In one embodiment, the second operation comprises a decoder for CSI compression based on the neural network.

In one embodiment, the second operation comprises a CNN-based encoder for CSI compression.

In one embodiment, the second operation is performed by the physical layer of the second node.

In one embodiment, the second operation is performed by the higher layer of the second node.

### Embodiment 13

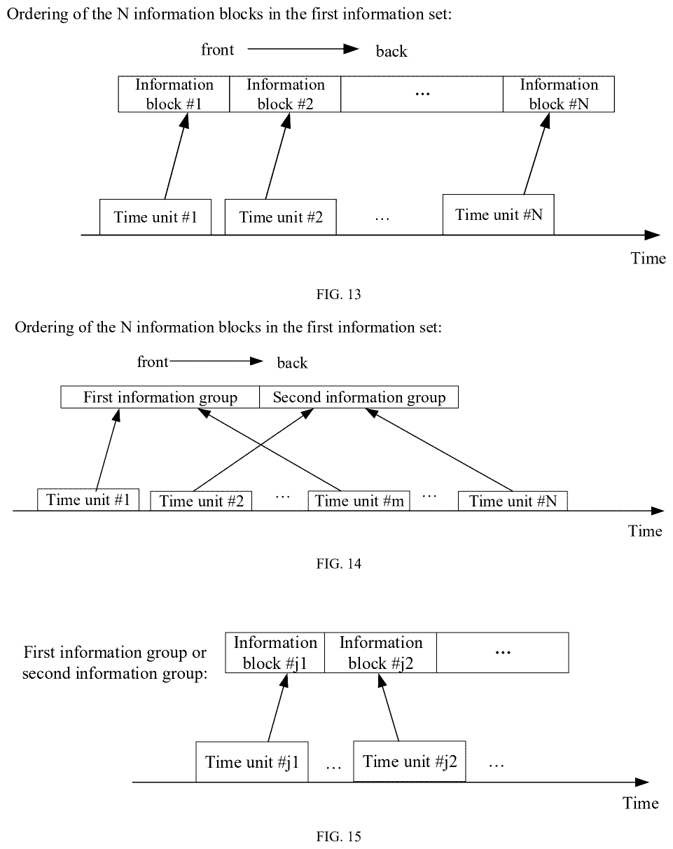

Embodiment 13 illustrates a schematic diagram of an ordering of N information blocks in a first information set depending on an ordering of N time units according to one embodiment of the present application, as shown in FIG. 13. In FIG. 13, information block #1, . . . , information block #N respectively represent the 1st to the Nth information blocks among N information blocks arranged in the first information set; time unit #1, . . . , time unit #N respectively represent the 1st to the Nth time units among N time units arranged in an ascending chronological order.

In embodiment 13, in the first information set, the N information blocks are arranged in ascending order of their corresponding time units.

In one embodiment, in the first information set, the N information blocks are arranged in ascending order of their corresponding time units, comprising: a k-th information block among the N information blocks is a k-th earliest information block in a chronological order within the N information blocks; k=1, . . . , N.

### Embodiment 14

Embodiment 14 illustrates a schematic diagram of an ordering of N information blocks in a first information set depending on an ordering of N time units according to another embodiment of the present application, as shown in FIG. 14. In embodiment 14, a first time unit group comprises time unit(s) with position belongs to a first position group among the N time units, and a second time unit group comprises time unit(s) with position belongs to a second position group among the N time units, the second position group being different from the first position group; a first information group comprises information block(s) corresponding to time unit(s) in the first time unit group among the N information blocks; a second information group comprises information block(s) corresponding to time unit(s) in the second time unit group among the N information blocks; in the first information set, the first information group is prior to the second information group.

Typically, the first position group is orthogonal to the second position group.

In one embodiment, the first position group comprises odd-numbered positions, and the second position group comprises even-numbered positions.

In one embodiment, the first position group comprises first N1 position(s), and the second position group comprises remaining N−N1 position(s), N1 being a positive integer less than N.

In one embodiment, a first position group comprises at least one positive integer in 1, . . . , N, and a second position group comprises at least one positive integer in 1, . . . , N, where any positive integer in the first position group does not belong to the second position group; a given time unit is a k-th time unit among the N time units, k being a positive integer not greater than N; k=1, . . . , N; a position of the given time unit is k.

In one embodiment, a first position group comprises odd-numbered positions from 1 to N, and a second position group comprises even-numbered positions from 1 to N; a given time unit is a k-th time unit among the N time units, k being a positive integer not greater than N; k=1, . . . , N; a position of the given time unit is k.

In one embodiment, a first time-unit group comprises time units in odd-numbered positions among the N time units, and a second time-unit group comprises time units in even-numbered positions among the N time units; a first information group comprises information block(s) corresponding to time unit(s) in the first time unit group among the N information blocks; a second information group comprises information block(s) corresponding to time unit(s) in the second time unit group among the N information blocks; in the first information set, the first information group is prior to the second information group.

In one embodiment, a first time-unit group comprises the 1st, 3rd, . . . time units among the N time units, and a second time-unit group comprises the 2nd, 4th, . . . time units among the N time units; a first information group comprises information block(s) corresponding to time unit(s) in the first time unit group among the N information blocks; a second information group comprises information block(s) corresponding to time unit(s) in the second time unit group among the N information blocks; in the first information set, the first information group is prior to the second information group.

In the aforementioned method, channel information of odd-positioned time units is arranged prior to channel information of even-positioned time units. This approach offers the advantages that when CSI omission occurs, the channel information of the odd-positioned time units is preferentially preserved. Compared to the arrangement of time units in an ascending chronological order, this method enables the reporting of channel information from more distant future time periods, thereby reducing feedback latency and enhancing the timeliness of channel information acquisition.

In one embodiment, the N time units are arranged in an ascending chronological order, comprising: a k-th time unit of the N time units is a k-th earliest time unit among the N time units; k=1, . . . , N.

In one embodiment, an ordering of the N time units is autonomously determined by the first node.

In one embodiment, an ordering of the N time units is reported by the first node to a transmitter of the first configuration information block.

### Embodiment 15

Embodiment 15 illustrates a schematic diagram of an ordering of information blocks in a first information group and a second information group according to one embodiment of the present application, as shown in FIG. 15.

In embodiment 15, when the first information group comprises multiple information blocks among the N information blocks, in the first information set, the multiple information blocks in the first information group are arranged in an ascending chronological order according to their corresponding time units; when the second information group comprises multiple information blocks among the N information blocks, in the first information set, the multiple information blocks in the second information group are arranged according to their corresponding time units in an ascending chronological order. In FIG. 15, time unit #j1 and time unit #j2 represent time units in the first time unit group of the present application, and information block #j1 and information block #j2 represent sequentially arranged information blocks in the first information group; alternatively, time unit #j1 and time unit #j2 represent time units in the second time unit group of the present application, and information block #j1 and information block #j2 represent sequentially arranged information blocks in the second information group.

### Embodiment 16

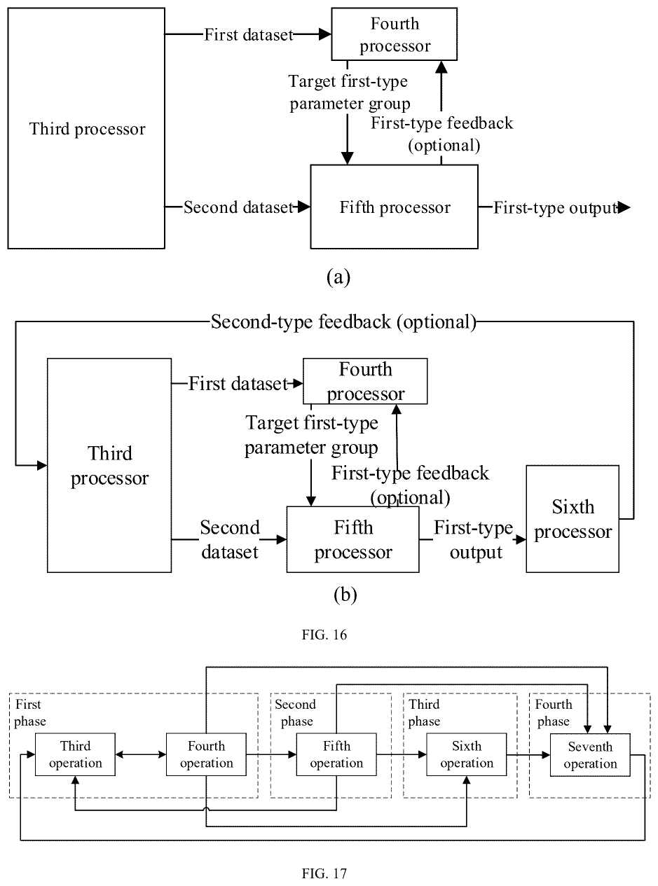

Embodiment 16 illustrates a schematic diagram of an AI/ML-based processor according to one embodiment of the present application, as shown in FIG. 16. FIG. 16(a) includes a third processor, a fourth processor, and a fifth processor, while FIG. 16(b) includes a third processor, a fourth processor, a fifth processor, and a sixth processor.

In embodiment 16 (a), the third processor transmits a first dataset to the fourth processor and a second dataset to the fifth processor; the fourth processor generates a target first-type parameter set according to the first dataset, and the fourth processor transmits the generated target first-type parameter set to the fifth processor; the fifth processor processes the second dataset using the target first-type parameter set to acquire a first-type output. In FIG. 16(a), a first-type feedback is optional.

In embodiment 16 (b), the third processor transmits a first dataset to the fourth processor and a second dataset to the fifth processor; the fourth processor generates a target first-type parameter set according to the first dataset, and the fourth processor transmits the generated target first-type parameter set to the fifth processor; the fifth processor processes the second dataset using the target first-type parameter set to acquire a first-type output, and the fifth processor transmits the first-type output to the sixth processor. In FIG. 16(b), a first-type feedback and a second-type feedback is optional.

In one embodiment, in FIG. 16(a), the fifth processor transmits the first-type output to the second node in the present application.

In one embodiment, FIG. 16(a) shows the use of a single side AI model for beam prediction or channel information prediction, the fifth processor performs the first operation, and the first operation is used for beam prediction or channel information prediction.

In one embodiment, FIG. 16(b) uses a two-sided AI model for CSI compression, where the first operation is used to compress CSI, the second operation is used to recover CSI, the fifth processor performs the first operation, and the sixth processor comprises the second operation.

In one embodiment, the AI comprises ML inference.

In one embodiment, the fifth processor comprises performing the first operation.

In one embodiment, the sixth processor comprises the second operation.

In one embodiment, the fifth processor transmits a first-type feedback to the fourth processor, and the first-type feedback is used to trigger a recalculation or update of the target first-type parameter group.

In one embodiment, the sixth processor transmits a second-type feedback to the third processor, the second-type feedback is used to generate the first data set or the second data set, or the second-type feedback is used to trigger a transmission of the first data set or a transmission of the second data set.

In one embodiment, the third processor generates the first data set and the second data set based on a measurement for the first-type radio signal, and the first-type radio signal comprises a downlink RS.

In one embodiment, the fifth processor belongs to the first node, and the sixth processor belongs to the second node.

In one embodiment, the first CSI belongs to the first-type output.

In one embodiment, the second dataset comprises the input of the first operation.

In one embodiment, the second dataset comprises information acquired based on the first configuration and M1 configurations.

In one embodiment, the first dataset comprises training data.

In one embodiment, the fourth processor belongs to a producer of the first operation.

In one embodiment, the fourth processor comprises an AI training producer.

In one embodiment, the fourth processor comprises an AI training function.

In one embodiment, the fourth processor is used for model training, and the trained model is described by the target first-type parameter set.

In one embodiment, the fourth processor belongs to the first node.

The above embodiment avoids passing the first data set to the second node.

In one embodiment, the fourth processor belongs to the second node.

The above embodiments support joint training, thereby optimizing the system performance.

In one embodiment, the fourth processor belongs to the core network.

The above embodiments support joint training across the entire network, further optimizing the system performance.

In one embodiment, the second dataset comprises inference data.

In one embodiment, the fifth processor comprises an AI inference producer.

In one embodiment, the fifth processor comprises an AI inference function.

In one embodiment, the fifth processor belongs to the first node.

In one embodiment, the fifth processor constructs a model according to the target first-type parameter set, and then inputs the second data set into the constructed model to acquire the first-type output.

In one embodiment, the first operation is described by the target first-type parameter set.

In one embodiment, the target first-type parameter group is used to construct the first operation.

In one embodiment, the fifth processor comprises the second operation.

In one embodiment, the fifth processor generates a recovered dataset according to the first-type output, and an error between the recovered data set and the second data set is used to generate the first-type feedback.

In one subembodiment of the above embodiment, the generation of the recovery dataset adopts a similar second operation.

In one embodiment, the first-type feedback is used to reflect the performance of the trained model; when the performance of the trained model cannot meet the requirements, the fourth processing opportunity recalculates the target first-type parameter group.

In one embodiment, the performance of the trained model is deemed unsatisfactory when the error exceeds acceptable thresholds or remains unupdated for an extended period.

In one embodiment, the target first-type parameter group comprises: one or more of the convolution kernel size, number of convolution layers, convolution step-size, pooling kernel size, pooling function, activation function, or number of feature maps.

In one embodiment, the target first-type parameter group comprises: one or more of convolutional kernel, pooling kernel, pooling function, activation function, parameters of the pooling function, or the parameters of the activation function.

### Embodiment 17

Embodiment 17 illustrates a schematic diagram of based on artificial intelligence or machine learning according to one embodiment of the present application, as shown in FIG. 17. FIG. 17 comprises a third operation, a fourth operation, a fifth operation, a sixth operation, and a seventh operation. In Embodiment 17, the third operation and fourth operation belong to a first phase, the fifth operation belongs to a second phase, the sixth operation belongs to a third phase, and the seventh operation belongs to a fourth phase. In FIG. 17, the arrowed lines represent the sequence of the process.

In one embodiment, the third operation comprises AI training, the fourth operation comprises AI testing, the fifth operation comprises AI emulation, the sixth operation comprises AI entity loading, and the seventh operation comprises AI inference.

In one embodiment, the first phase comprises a training phase, the second phase comprises an emulation phase, the third phase comprises a deployment phase, and the fourth phase comprises an inference phase.

In one embodiment, the first phase comprises the AI model training.

In one embodiment, the first phase comprises the AI model training and the AI testing.

In one embodiment, the AI comprises Machine Learning (ML) inference.

In one embodiment, the AI model training comprises initial training and retraining of one or a group of AI entities.

In one embodiment, the AI model training depends on training data.

In one embodiment, the AI model training comprises AI entity validation.

In one embodiment, the AI entity validation is used to evaluate the performance of the AI entity.

In one embodiment, the AI entity validation depends on validation data.

In one embodiment, if the results of AI entity validation do not meet expectations, the AI model is retrained.

In one embodiment, the AI testing comprises testing the validated AI entities to evaluate the performance of the trained AI model.

In one embodiment, if the results of AI testing meet expectations, the AI entity advances to the next phase; otherwise, the AI model is retrained.

In one embodiment, the AI testing depends on testing data.

In one embodiment, the second phase comprises AI emulation, and the AI emulation performs inference of AI entities in an emulation environment.

In one embodiment, the AI emulation provides an evaluation of the performance of AI entity inference in an emulation environment before using AI entities.

In one embodiment, the second phase is optional.

In one embodiment, the third phase comprises AI entity loading, and the AI entity loading is aimed at acquiring trained AI entities to achieve a desired AI inference function.

In one embodiment, the third phase is optional.

In one embodiment, when the training function and inference function are co-located, the third phase is no longer required.

In one embodiment, the fourth phase comprises AI inference.

In one embodiment, the seventh operation comprises the first operation.

In one embodiment, the seventh operation comprises the second operation.

### Embodiment 18

Embodiment 18 illustrates a structure block diagram of a processor in a first node according to one embodiment of the present application, as shown in FIG. 18. In FIG. 18, a processor 1800 in a first node comprises a first receiver 1801 and a first processor 1802.

In one embodiment, the first node is a UE.

In one embodiment, the first node is a relay node.

In one embodiment, the first receiver 1801 comprises at least one of the antenna 452, the receiver 454, the receiving processor 456, the multi-antenna receiving processor 458, the controller/processor 459, the memory 460, or the data source 467 in Embodiment 4.

In one embodiment, the first processor 1802 comprises at least one of the antenna 452, the receiver/transmitter 454, the receiving processor 456, the transmitting processor 468, the multi-antenna receiving processor 458, the multi-antenna transmitting processor 457, the controller/processor 459, the memory 460 or the data source 467 in Embodiment 4.

The first receiver 1801 receives a first configuration information block; the first configuration information block indicates a first resource set;
a first processor 1802 performs a first operation, an input of the first operation depends on a measurement based on the first resource set; transmits a first signal, the first signal carries a first information set, the first information set depends on an output of the first operation;
in embodiment 18, the first information set comprises N information blocks, the N information blocks respectively comprise channel information for N time units, N being a positive integer greater than 1; an ordering of the N information blocks in the first information set depends on an ordering of the N time units.

In one embodiment, the first receiver 1801 receives a signal in the first resource set.

In one embodiment, the first receiver 1801 receives a reference signal in the first resource set, and the first resource set comprises one or multiple RS resources.

In one embodiment, the first operation is training-based or AI-based.

In one embodiment, the first operation requires deployment.

In one embodiment, the first operation is acquired through loading.

In one embodiment, any one of the N information blocks indicates at least one resource in a second resource set, and the second resource set comprises resources not belonging to the first resource set.

In one embodiment, the first receiver receives a signal in the second resource set.

In one embodiment, the first receiver receives a reference signal in the second source set, and the second resource set comprises one or multiple RS resources.

In one embodiment, the first receiver does not receive a signal in the second resource set.

In one embodiment, the first configuration information block indicates a first identifier, and the first operation is associated with the first identifier.

In one embodiment, in the first information set, the N information blocks are arranged in ascending order of their corresponding time units.

In one embodiment, a first time unit group comprises time unit(s) with position belongs to a first position group among the N time units, and a second time unit group comprises time unit(s) with position belongs to a second position group among the N time units, the second position group being different from the first position group; a first information group comprises information block(s) corresponding to time unit(s) in the first time unit group among the N information blocks; a second information group comprises information block(s) corresponding to time unit(s) in the second time unit group among the N information blocks; in the first information set, the first information group is prior to the second information group.

In one embodiment, when the first information group comprises multiple information blocks among the N information blocks, in the first information set, the multiple information blocks in the first information group are arranged according to their corresponding time units in an ascending chronological order; when the second information group comprises multiple information blocks among the N information blocks, in the first information set, the multiple information blocks in the second information group are arranged according to their corresponding time units in an ascending chronological order.

In one embodiment, the first information set also indicates at least one of N, the N time units, or an ordering of the N time units.

In one embodiment, the first processor 1802 deploys the first operation.

In one embodiment, an output of the first operation comprises a first CSI, the first information set carries the first CSI, the first CSI serves as an input of a second operation by a target receiver of the first information set to generate a second CSI.

### Embodiment 19

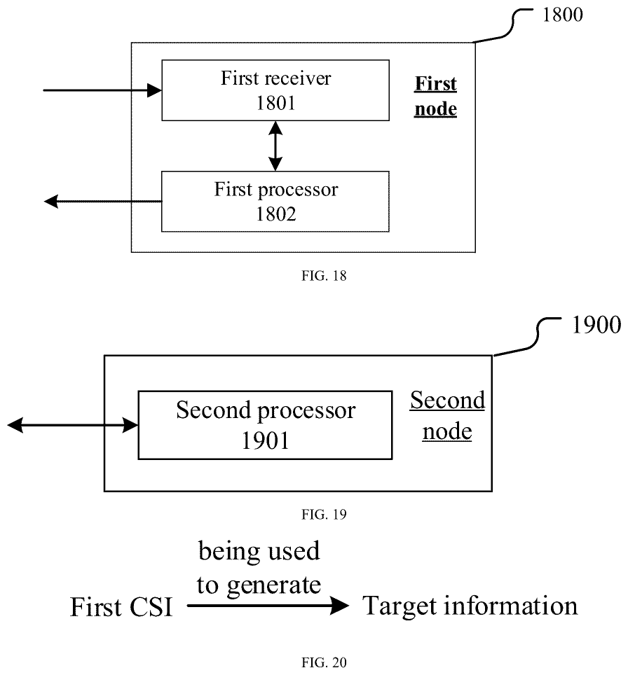

Embodiment 19 illustrates a structure block diagram of a processor in a second node according to one embodiment of the present application, as shown in FIG. 19. In FIG. 19, a processor 1900 in the second node comprises a second processor 1901.

In one embodiment, the second node is a base station.

In one embodiment, the second node is a UE.

In one embodiment, the second node is a relay node.

In one embodiment, the second processor 1901 comprises at least one of the antenna 420, the receiver/transmitter 418, the receiving processor 470, the transmitting processor 416, the multi-antenna receiving processor 472, the multi-antenna transmitting processor 471, the controller/processor 475, or the memory 476 in Embodiment 4.

The second processor 1901 transmits a first configuration information block, the first configuration information block indicates a first resource set; receives a first signal, the first signal carries a first information set.

In embodiment 19, a target receiver of the first configuration information block performs a first operation, and an input of the first operation depends on a measurement based on the first resource set, and the first information set depends on an output of the first operation; the first information set comprises N information blocks, and the N information blocks each comprise channel information of N time units, N being a positive integer greater than 1; an ordering of the N information blocks in the first information set depends on an ordering of the N time units.

In one embodiment, the second processor 1901 transmits a signal in the first resource set.

In one embodiment, the first operation is training-based or AI-based.

In one embodiment, the first operation requires deployment.

In one embodiment, the first operation is acquired through loading.

In one embodiment, any one of the N information blocks indicates at least one resource in a second resource set, and the second resource set comprises resources not belonging to the first resource set.

In one embodiment, the second processor 1901 transmits a signal in the second resource set.

In one embodiment, the second processor 1901 transmits a reference signal in the second resource set, and the second resource set comprises one or multiple RS resources.

In one embodiment, the second processor 1901 does not transmit a signal in the first resource set.

In one embodiment, the second processor 1901 does not transmit a reference signal in the second resource set.

In one embodiment, the first configuration information block indicates a first identifier, and the first operation is associated with the first identifier.

In one embodiment, in the first information set, the N information blocks are arranged in ascending order of their corresponding time units.

In one embodiment, a first time unit group comprises time unit(s) with position belongs to a first position group among the N time units, and a second time unit group comprises time unit(s) with position belongs to a second position group among the N time units, the second position group being different from the first position group; a first information group comprises information block(s) corresponding to time unit(s) in the first time unit group among the N information blocks; a second information group comprises information block(s) corresponding to time unit(s) in the second time unit group among the N information blocks; in the first information set, the first information group is prior to the second information group.

In one embodiment, when the first information group comprises multiple information blocks among the N information blocks, in the first information set, the multiple information blocks in the first information group are arranged according to their corresponding time units in an ascending chronological order; when the second information group comprises multiple information blocks among the N information blocks, in the first information set, the multiple information blocks in the second information group are arranged according to their corresponding time units in an ascending chronological order.

In one embodiment, the first information set also indicates at least one of N, the N time units, or an ordering of the N time units.

In one embodiment, the second processor 1901 performs a second operation; herein, an output of the first operation comprises a first CSI, the first information set carries the first CSI, and the first CSI serves as an input for the second operation to generate a second CSI.

In one embodiment, the second processor 1901 deploys the second operation.

In one embodiment, the second operation is training-based or AI-based.

In one embodiment, the second operation is acquired through loading.

### Embodiment 20

Embodiment 20 illustrates a schematic diagram of a first information set according to one embodiment of the present application, as shown in FIG. 20. In embodiment 20, an output of the first operation comprises a first CSI, and the first CSI is used to generate the first information set.

In one embodiment, advantages of the above method include utilizing the advantages of the first operation to improve the performance of CSI reporting, including more accurate reporting and/or lower overhead.

In one embodiment, the first information set comprises the first CSI.

In one embodiment, the first CSI, after being post-processed, is used to generate the first information set.

In one embodiment, the first information set comprises the first CSI that undergoes post-processing.

In one embodiment, the first information set carries the first CSI that undergoes post-processing.

In one embodiment, the first CSI, after being truncated and/or quantized, is used to generate the first information set.

In one embodiment, the first information set comprises the first CSI that undergoes truncation and/or quantization.

In one embodiment, the first information set carries the first CSI that undergoes truncation and/or quantization.

In one embodiment, the first CSI comprises one or more of PMI, CRI, CQI, RI, L1, SSBRI, RSRP, SINR, capability Index, and TDCP.

In one embodiment, the first CSI comprises a channel matrix.

In one embodiment, the first CSI comprises an eigenvector.

In one embodiment, the first CSI comprises an eigenvector and an eigenvalue.

In one embodiment, the first CSI comprises precoding information.

In one embodiment, the first CSI comprises non-codebook-based pre-coding information.

In one embodiment, the first CSI is used to determine at least one pre-coding matrix.

In one embodiment, the first CSI indicates at least one pre-coding matrix.

In one embodiment, the precoding matrix is in spatial-frequency domain.

In one embodiment, the precoding matrix is an angular delay domain projection.

In one embodiment, the first CSI comprises information on relative phase, amplitude, and/or coefficient between multiple antenna ports.

In one embodiment, the first CSI comprises a compress CSI.

In one embodiment, the first CSI comprises a predicted/evaluated CSI.

The ordinary skill in the art may understand that all or part of steps in the above method may be implemented by instructing related hardware through a program. The program may be stored in a computer readable storage medium, for example Read-Only Memory (ROM), hard disk or compact disc, etc. Optionally, all or part of steps in the above embodiments also may be implemented by one or more integrated circuits. Correspondingly, each module unit in the above embodiment may be realized in the form of hardware, or in the form of software function modules. The user equipment, terminal and UE include but are not limited to Unmanned Aerial Vehicles (UAVs), communication modules on UAVs, telecontrolled aircrafts, aircrafts, diminutive airplanes, mobile phones, tablet computers, notebooks, vehicle-mounted communication equipment, vehicles, cars, RSUs, wireless sensors, network cards, Internet of Things (IoT) terminals, RFID terminals, NB-IoT terminals, Machine Type Communication (MTC) terminals, enhanced MTC (eMTC) terminals, data card, network cards, vehicle-mounted communication equipment, low-cost mobile phones, low-cost tablets and other wireless communication devices. The base station or system equipment in the present application includes but is not limited to macro-cellular base stations, micro-cellular base stations, Pico base stations, home base stations, relay base stations, eNB, gNB, Transmitter Receiver Points (TRPs), GNSS, relay satellites, satellite base stations, space base stations, RSUs, UAVs, test devices, such as a transceiver or a signaling tester that simulates some functions of a base station, and other wireless communication devices.

It will be appreciated by those skilled in the art that this disclosure can be implemented in other designated forms without departing from the core features or fundamental characters thereof. The currently disclosed embodiments, in any case, are therefore to be regarded only in an illustrative, rather than a restrictive sense. The scope of invention shall be determined by the claims attached, rather than according to previous descriptions, and all changes made with equivalent meaning are intended to be included therein.

What is claimed is:

1. A first node for wireless communications, comprising:
a first receiver, receiving a first configuration information block; the first configuration information block indicating a first resource set;
a first processor, performing a first operation, an input of the first operation depending on a measurement based on the first resource set; transmitting a first signal, the first signal carrying a first information set, and the first information set depending on an output of the first operation;
wherein the first information set comprises N information blocks, the N information blocks respectively comprise channel information for N time units, N being a positive integer greater than 1; an ordering of the N information blocks in the first information set depends on an ordering of the N time units.

2. The first node according to claim 1, wherein the first operation is training-based or AI (Artificial Intelligence)-based;
or,
the first configuration information block indicates a first identifier, and the first operation is associated with the first identifier.

3. The first node according to claim 1, wherein any one of the N information blocks indicates at least one resource in a second resource set, and the second resource set comprises resources not belonging to the first resource set.

4. The first node according to claim 1, wherein in the first information set, the N information blocks are arranged in ascending order of their corresponding time units.

5. The first node according to claim 1, wherein a first time unit group comprises time unit(s) with position belongs to a first position group among the N time units, and a second time unit group comprises time unit(s) with position belongs to a second position group among the N time units, the second position group being different from the first position group; a first information group comprises information block(s) corresponding to time unit(s) in the first time unit group among the N information blocks; a second information group comprises information block(s) corresponding to time unit(s) in the second time unit group among the N information blocks; in the first information set, the first information group is prior to the second information group.

6. The first node according to claim 5, wherein when the first information group comprises multiple information blocks among the N information blocks, in the first information set, the multiple information blocks in the first information group are arranged in ascending order of their corresponding time units; when the second information group comprises multiple information blocks among the N information blocks, in the first information set, the multiple information blocks in the second information group are arranged in ascending order of their corresponding time units.

7. A second node for wireless communications, comprising:
a second processor, transmitting a first configuration information block, the first configuration information block indicating a first resource set; receiving a first signal, the first signal carrying a first information set;
wherein a target receiver of the first configuration information block performs a first operation, and an input of the first operation depends on a measurement based on the first resource set, and the first information set depends on an output of the first operation; the first information set comprises N information blocks, and the N information blocks respectively comprise channel information of N time units, N being a positive integer greater than 1; an ordering of the N information blocks in the first information set depends on an ordering of the N time units.

8. The second node according to claim 7, wherein the first operation is training-based or AI (Artificial Intelligence)-based;
or,
the first configuration information block indicates a first identifier, and the first operation is associated with the first identifier.

9. The second node according to claim 7, wherein any one of the N information blocks indicates at least one resource in a second resource set, and the second resource set comprises resources not belonging to the first resource set.

10. The second node according to claim 7, wherein in the first information set, the N information blocks are arranged in ascending order of their corresponding time units.

11. The second node according to claim 7, wherein a first time unit group comprises time unit(s) with position belongs to a first position group among the N time units, and a second time unit group comprises time unit(s) with position belongs to a second position group among the N time units, the second position group being different from the first position group; a first information group comprises information block(s) corresponding to time unit(s) in the first time unit group among the N information blocks; a second information group comprises information block(s) corresponding to time unit(s) in the second time unit group among the N information blocks; in the first information set, the first information group is prior to the second information group.

12. A method in a first node for wireless communications, comprising:
receiving a first configuration information block; the first configuration information block indicating a first resource set;
performing a first operation, an input of the first operation depending on a measurement based on the first resource set;
transmitting a first signal, the first signal carrying a first information set, the first information set depending on an output of the first operation;
wherein the first information set comprises N information blocks, the N information blocks respectively comprise channel information for N time units, N being a positive integer greater than 1; an ordering of the N information blocks in the first information set depends on an ordering of the N time units.

13. The method according to claim 12, wherein the first operation is training-based or AI (Artificial Intelligence)-based;
or,
the first configuration information block indicates a first identifier, and the first operation is associated with the first identifier.

14. The method according to claim 12, wherein in the first information set, the N information blocks are arranged in ascending order of their corresponding time units.

15. The method according to claim 12, wherein a first time unit group comprises time unit(s) with position belongs to a first position group among the N time units, and a second time unit group comprises time unit(s) with position belongs to a second position group among the N time units, the second position group being different from the first position group; a first information group comprises information block(s) corresponding to time unit(s) in the first time unit group among the N information blocks; a second information group comprises information block(s) corresponding to time unit(s) in the second time unit group among the N information blocks; in the first information set, the first information group is prior to the second information group.

16. The method according to claim 15, wherein when the first information group comprises multiple information blocks among the N information blocks, in the first information set, the multiple information blocks in the first information group are arranged in ascending order of their corresponding time units; when the second information group comprises multiple information blocks among the N information blocks, in the first information set, the multiple information blocks in the second information group are arranged in ascending order of their corresponding time units.

17. A method in a second node for wireless communications, comprising:
transmitting a first configuration information block, the first configuration information block indicating a first resource set; and
receiving a first signal, the first signal carrying a first information set;
wherein a target receiver of the first configuration information block performs a first operation, and an input of the first operation depends on a measurement based on the first resource set, and the first information set depends on an output of the first operation; the first information set comprises N information blocks, and the N information blocks respectively comprise channel information of N time units, N being a positive integer greater than 1; an ordering of the N information blocks in the first information set depends on an ordering of the N time units.

18. The method according to claim 17, wherein the first operation is training-based or AI (Artificial Intelligence)-based;
or,
the first configuration information block indicates a first identifier, and the first operation is associated with the first identifier.

19. The method according to claim 17, wherein in the first information set, the N information blocks are arranged in ascending order of their corresponding time units.

20. The method according to claim 17, wherein a first time unit group comprises time unit(s) with position belongs to a first position group among the N time units, and a second time unit group comprises time unit(s) with position belongs to a second position group among the N time units, the second position group being different from the first position group; a first information group comprises information block(s) corresponding to time unit(s) in the first time unit group among the N information blocks; a second information group comprises information block(s) corresponding to time unit(s) in the second time unit group among the N information blocks; in the first information set, the first information group is prior to the second information group.
